(19) United States
(12) Patent Application Publication
(10) Pub. No.: US 2019/0043380 A1
(43) Pub. Date: Feb. 7, 2019

(54) METHODS AND SYSTEMS FOR IMPROVING LEARNING EXPERIENCE IN GAMIFICATION PLATFORM

(71) Applicant: TOOLWIRE, Inc., Pleasanton, CA (US)

(72) Inventors: David James Clarke, IV, Pleasanton, CA (US); Chris Thompson, Bremerton, WA (US); Hugo Lebegue, Livermore, CA (US)

(21) Appl. No.: 15/707,881

(22) Filed: Sep. 18, 2017

Related U.S. Application Data
(60) Provisional application No. 62/395,796, filed on Sep. 16, 2016.

(51) Int. Cl. G09B 7/08; G09B 5/14; G09B 19/00; G09B 5/06; A63F 13/85; G09B 5/12; G09B 7/07

(52) U.S. Cl. CPC G09B 7/08; G09B 5/14; G09B 19/0053; G06N 99/005; A63F 13/85; G09B 5/12; G09B 7/07; G09B 5/065

(57) ABSTRACT

Example methods, apparatuses, and systems (e.g., machines) are presented for a gamification platform that is the first automated, machine-based system to seamlessly integrate and deliver personalized remediation, centralized learning resources, experiential learning labs, peer and mentor collaboration, immersive scenario-based story, gamified scoring, and real-time heuristics to a user in a learning and training environment. In some embodiments, the gamification platform may be configured to ingest pre-existing training material or other teaching curricula and create an interactive gaming program around the exercise of the training material by a user.

### CROSS REFERENCE TO RELATED APPLICATION

This application claims the benefit of U.S. Provisional Application 62/395,796, filed Sep. 16, 2016, and titled “METHODS AND SYSTEMS FOR GAMIFICATION PLATFORM,” the disclosure of which is hereby incorporated herein in its entirety and for all purposes.

### TECHNICAL FIELD

Aspects of the present disclosure generally pertain to processing data. More specifically, the present disclosure relates to methods and systems for providing a gamification platform that incorporates client teaching curricula into an interactive gamification program.

### BACKGROUND

With the many forms of media and entertainment available these days, learning leaders charged with developing economically scalable learning programs face many significant challenges. Many studies and different theories of learning have been offered to help determine how people learn and what can help incentivize learning. More resources are then devoted to building programs and applications for employing these techniques. It is desirable to efficiently incorporate existing teaching material into new and improved mediums for incentivizing learning.

### SUMMARY

Aspects of the present disclosure are presented for a system and method of a gamification platform. In some embodiments, a system for converting client training material into an interactive gamification program is presented. The system may include: at least one processor; and at least one memory coupled to the at least one processor; the at least one processor configured to: access client training material provided by the client from an external source; integrate the client training material into an interactive gamification program, the gamification program including: a plurality of learning modules that include subsets of training material from the client training material; a user interface of accessing the plurality of learning modules; a testing module configured to assess a user's proficiency of each subset of training material among the client training material; a storyline comprised of story chapters that a user progressively unlocks based on the user progressively showing proficiency of each subset of training material provided by the client; and an achievement module comprising a record of achievements earned by the user for demonstrating proficiency of each subset of training material; and cause display of the user interface to allow interaction with the gamification program.

In some embodiments of the system, the gamification program further includes: a pre-assessment program configured to determine the user's proficiency in each of the plurality of learning modules before the user interfaces with any of the plurality of learning modules; and a real-time personalized learning plan module configured to generate a set of personalized training material derived from the client training material that addresses deficiencies in the user's understanding of the plurality of learning modules based on results from the pre-assessment program; wherein the at least one processor is further configured to integrate the personalized training material into the storyline such that the story chapters are progressively unlocked based on the user showing progressive proficiency of progressively more challenging portions of the personalized training material.

In some embodiments of the system, the personalized learning plan module is configured to generate the set of personalized training material based further from machine learning techniques that analyze how long the user spent on questions in the pre-assessment program and a plurality of ratings provided by a plurality of users that rate how valuable questions in the pre-assessment program are.

In some embodiments of the system, the personalized learning plan module is configured to generate the set of personalized training material based further from machine learning techniques that analyze past personalized training materials of past users to determine how effective the past personalized training materials were in addressing deficiencies in the past users.

In some embodiments of the system, the at least one processor is further configured to: store test results of the user for each subset of the training material in the at least one memory; aggregate a plurality of test results from a plurality of other users along with the rest results of the user; and generate predictive performance results of the plurality of other users and the user that generalize an overall proficiency among the plurality of other users and the user.

In some embodiments of the system, the at least one processor is further configured to cause display of a dashboard summarizing the predictive performance results.

In some embodiments of the system, the at least one processor is further configured to: store, in the at least one memory, a level of user activity by the user interfacing with gamification program; and predict a level of training module completion based on the stored level of user activity.

In some embodiments of the system, the at least one processor is further configured to: store, in the at least one memory, an amount of time spent by the user interfacing with a particular training module; and predict a probability of success that the user will complete said particular training module based on the stored level of amount of time.

In some embodiments of the system, the gamification program further includes an adaptive analytical module configured to: analyze the user's progress in the plurality of learning modules; and cause display of suggested supplemental learning resources to aide the user in improving proficiency of at least one of the plurality of learning modules.

In some embodiments of the system, the analytical module is further configured to calculate a correlation between performance-based and knowledge-based assessments and revise the plurality of learning modules to remove a learning module that shows low effectiveness in improving proficiency or adds a learning module that shows high effectiveness in improving proficiency.

In some embodiments, a method by a gamification platform for converting client training material into an interactive gamification program is presented. The method may include: accessing the client training material provided by the client from an external source; integrating the client training material into an interactive gamification program; generating a plurality of learning modules in the gamification program that include subsets of training material from the client training material; generating a user interface for accessing the plurality of learning modules; generating a testing module in the gamification platform configured to assess a user's proficiency of each subset of training material among the client training material; generating a storyline comprised of story chapters that a user progressively unlocks based on the user progressively showing proficiency of each subset of training material provided by the client; generating an achievement module comprising a record of achievements earned by the user for demonstrating proficiency of each subset of training material; and causing display of the user interface to allow interaction with the gamification program.

### BRIEF DESCRIPTION OF THE DRAWINGS

Some embodiments are illustrated by way of example and not limitation in the figures of the accompanying drawings.

FIG. 1 shows an example illustration of a gamification platform architecture and workflow.

FIG. 2 shows an example illustration of a gamification engineering architecture diagram.

FIG. 3 shows an example illustration of a gamification collaboration panel.

FIG. 4 shows an example illustration of a gamification nudging architecture.

FIG. 5 shows an example illustration of a gamification learner flow.

FIG. 6 shows an example illustration of a gamification mission flow.

FIG. 7 shows an example illustration of a gamification mission room to launch mission briefings.

FIG. 8 shows an example illustration of a gamification game status screen.

FIG. 9 shows an example illustration of skills tracking tokens and badges of a user utilizing the gamification platform.

FIG. 10 shows an example illustration of skills tracking tokens as learning resources made available to a user utilizing the gamification platform.

FIG. 11 shows an example illustration of a personalized learning plan (PLP) brain scan architecture.

FIG. 12 shows an example illustration of a PLP remediation matrix and engagement flow.

FIG. 13 shows an example illustration of a PLP brain scan screen.

FIG. 14 shows an example illustration of a PLP brain scan item interface.

FIG. 15 shows an example illustration of a PLP readiness profile screen.

FIG. 16 shows an example illustration of a PLP suggested learning resources screen.

FIG. 17 shows an example illustration of an experiential learning labs desktop.

FIG. 18 shows an example illustration of an experiential learning lab guide frame.

FIG. 19 shows an example illustration of an experiential learning labs help panel.

FIG. 20 shows an example illustration of an experiential learning labs flow.

FIG. 21 shows an example illustration of a mission quest performance assessment.

FIG. 22 shows an example illustration of a mission quest validator.

FIG. 23 shows an example illustration of a gamification heuristics data model.

FIG. 24 shows an example illustration of a gamification heuristics mission dashboard.

FIG. 25 shows an example illustration of a gamification heuristics learner dashboard.

FIG. 26 shows an example illustration of a gamification aggregate mission dashboard.

FIG. 27 shows an example illustration of a gamification heuristics aggregated dashboard.

FIG. 28 shows an example illustration of a gamification aggregate mission leaderboard.

FIG. 29 shows an example illustration of a report of resource efficacy heuristics.

FIG. 30 shows an example main menu for a gaming environment generated by the gamification platform of the present disclosure, where a user can access the courses that apply to the user's role in the company.

FIG. 31 shows a “Badges” menu to show the badges the user has earned so far.

FIG. 32 shows a “Leaderboard” screen that can be accessed to see how the user compares to other learners in the gaming environment system.

FIG. 33 shows how the user can also select “Courses” from the main menu and then select the “Java Programming” course, in this example, as one type of course that can be learned that is introduced into the gaming environment.

FIG. 34 shows a course menu for a particular course accessed from the main menu, such as the Java Programming selection from FIG. 33.

FIG. 35 shows a “Mosaic” screen that is accessed after selecting a particular mosaic, in this case the “Java Fundamentals” as an example.

FIG. 36 shows, from the Mosaic screen, how each tile may be selected to explore a particular competency. In this case, the “Methods and Constructors” Tile is selected.

FIG. 37 shows a Practice Lab environment to allow the user to gain more hands-on learning of the material.

FIG. 38 shows a quiz screen that the user can access to test mastery of the subject and to gain an achievement or badge.

FIG. 39 shows a second Tile related to a slightly different subject matter.

FIG. 40 shows an illustration of an example process for ingesting training material into the gamification platform.

FIG. 41 shows the results of one survey highlighting results from the use of various gaming environments generated by the gamification platform according to the present disclosure.

FIG. 42 is a block diagram illustrating components of a machine, according to some example embodiments, able to read instructions from a machine-readable medium and perform any one or more of the methodologies discussed herein.

### DETAILED DESCRIPTION

Aspects of the present disclosure are presented for a gamification platform that is the first automated, machine-based system to seamlessly integrate and deliver personalized remediation, centralized learning resources, experiential learning labs, peer and mentor collaboration, immersive scenario-based story, gamified scoring, and real-time heuristics to a user in a learning and training environment.

With the many forms of media and entertainment available these days, learning leaders charged with developing economically scalable learning programs face many significant challenges. To keep employees engaged and increasingly learning new skills and knowledge relevant to a company, learning leaders deal with several factors, including: keeping pace with accelerated depreciation of skills and knowledge; legacy learning management systems (LMSs) that are ill-equipped for content curation and personalized learning needs; and difficulty in scaling assessment/certification programs for on-the-job skills.

The gamification platform of the present disclosure allows for existing material in learning management systems to be integrated into a gamification environment. The gamification platform enables companies to leverage previous investments of time/money in legacy LMS systems while upgrading programs via a more scalable and sustainable infrastructure, optimized for the 21^{st} Century worker. Furthermore, by integrating existing material from existing LMS resources of the company, the gamification platform accelerates implementation time, and allows companies to maximize previous investments in content—both in-house and from 3^{rd}-party providers (e.g., SkillSoft, Pluralsight etc.).

In some embodiments, the gamification platform according to the present disclosure is configured to ingest existing teaching material of a client, e.g., learning leaders at a company, integrate the existing teaching material into a gaming environment, and deploy the gaming environment to the client such that a user of the gaming environment is able to be exposed to all of the teaching material while participating in the gaming environment. In this way, the gamification platform of the present disclosures uses the concepts of rewards systems and interactive engagement with the user to improve the user's learning experience. This in turn improves the user's ability to retain the knowledge and skills meant to be taught in the original set of teaching material. In some embodiments, the gamification platform of the present disclosure is configured to automatically create a gaming environment around the existing teaching material, once that material has been ingested into the platform.

The present disclosure relates to converting existing teaching material—even material that is based on paper handouts and physical hard copies—into a computerized gaming environment that automatically interacts with the user once completely integrated. The ability to improve a user's learning experience is based on the concept that presenting the existing teaching material in a gaming environment provides useful incentives for a user to play through the game, and naturally learn the material as the user goes along. For example, the user better retains the material being taught when it is presented in the form of a problem to be solved, or with the presence of a memorable achievement or reward. Furthermore, the gamification platform of the present disclosure includes the ability to convert different types of teaching material across diverse and varied disciplines and at different levels of complexity into a gaming environment. Therefore, improving the user's learning experience of the teaching material is inherently tied to the teaching material being converted into a computerized gaming environment that automatically interacts with the user as the user utilizes the interactive game. In contrast, the improvements presented by the present disclosure would not be achieved if the teaching material were merely repurposed manually, since at least part of the improvement to the user's learning experience is based on the teaching material being packaged and interacted with in a computerized gaming environment.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The following is a descriptive summary of the six components of the gamification platform of the present disclosures, according to some embodiments:

Personalized—the Personalized Learning Plan and Remediation Matrix are a collection of proprietary software code that calculates each learner's skills competency gaps using real-time data from pre-assessment exams. These results are fed into heuristic algorithms in the Remediation Matrix to provide a personalized set of learning resources at the objective level.

In some embodiments, the Personalized Learning Plan is recommended by a blend of machine learning algorithm analyzing usage data (time on task, point based system, access count, etc.) and user ratings performed by the learners population. The gamification platform may be configured to utilize machine learning to learn from previous learning plans and ratings, as well as performance data by past users, what plans are best suited for individuals, given various assessments pertaining to the users. In addition, the gamification platform completion is also part of the personalized plan. It can be triggered by scores, time on task, etc.

In some embodiments, the Personalization component (e.g., PLP, Remediations, and Spaced Repetition Schedule (SRS)) is based at least in part by certain algorithms. In some embodiments, utilized is a mathematical representation of the number of computations required to determine an optimal learning plan to a student. For example: u=number of users, q=number of assessment questions, c=number of competencies, r=number of resources, and m=resources to competencies mappings. The formula shows how as the number of resources and competencies grow, the computations experientially grow to a point that the only way this would work is via a machine. In general, the gamification platform may be configured to accommodate an arbitrary number of students—tens of thousands of them, while a human if they had enough time could only do a small fraction of them.

Experiential—the Experiential Learning Labs comprise proprietary software code, technology protocols, data algorithms, management software, and middleware to deliver dynamic, on-demand experiential learning labs within the iFrame of the gamification platform. Using a variety of proprietary machine-based routines, each learner's performance is assessed and automatically scored within the lab environment.

In some embodiments, hands on activities such as simulations and practice labs using a Virtual Desktop are accessible remotely simply by using a web browser. These are non-intrusive and completely scalable technology. The computerized interface for the gamification platform is inherent in its implementation, according to some embodiments, as non-computerized interfaces, i.e., manual applications performed or conducted by humans, would not achieve the desired user experience of automating the teaching material while still improving the learning experience of said material.

In some embodiments, a lab guide is also included as part of the gaming environment conversion. The lab guide offers immediate, multimedia guidance and set up information needed to complete the task—in a format that can be resized to a user's need. The validator offers real-time feedback on student work.

Analytical—the gamification platform includes data analytics and custom heuristic dashboards to provide client administrators with real-time predictive advice regarding the skills portfolio of their employees and future learning behaviors of individuals, groups, and the organization as a whole. In order to provide real-time predictive advice, the platform includes data analysis that correlates the time spent to study with a probability of success at the proctored assessment. One or more algorithms are provided that predicts the course completion level based on user activity compared to global averages. This may be based on machine learning techniques that aggregate past user experience data and continually adjust when new data is received.

As an example, the gamification platform according to some embodiments recognizes that customer have a plethora of learning resources for specific learning topics and there are many on the internet—much more than what is needed to master a topic so there is information overload. An issue then is how to provide users the most optimal path to mastery using the best and minimal number of resources possible needed for mastery.

Rather than having customers trying to figure out what learning resources to include in a gaming environment, the analytical component according to some embodiments uploads all learning resource to the gaming environment and some boundaries given, such as min/max number of resources to deliver. This removes the human guessing on what are the best learning resources. The gaming environment during runtime then provides a small subset of the learning resources to the user. Over time, the Machine Learning Engine continues to learn and improve upon learning resources delivered to students based on how students perform on the quiz/final assessments. As more result data is collected, ineffective resources are “weeded out” and only the best—most optimal learning resources remain. The learning continues as more results are added or if more resources are added to the gaming environment.

Remediation—the Collaboration Panel consists of customized communication protocols, software interfaces, and data models that provide real-time collaboration and messaging services for peer-to-peer, peer-to-mentor, and group interactions. The Collaboration Panel includes machine-based technology to facilitate instant messaging, voice-over-IP phone calls, email, file transfer, and proactive messaging.

In some embodiments, the remediation component includes adaptive nudging that delivers remediation feedback about progress, suggests learning resources, reminds about upcoming proctored assessment, and reminds of inactivity. The gamification platform's message bus personalizes the learning and remediation based on triggers. As far as the social aspect, the rating system is seamlessly integrated into the platform itself—the learner can rate immediately, without having to go anywhere. Further, discussion forums can be used to calculate ratings and inform the recommendation engine of popular resources.

Learning—the platform continually interacts with a proprietary data system including data analytics and custom heuristic algorithms that calculate the correlation between performance-based and knowledge-based assessments and the utilization of specific learning resources. After data analytics are gathered from thousands of learners, these heuristics inform the predictive software used in the remediation matrix to improve the effectiveness of learning resource recommendations.

The gamification platform allows for rating of the different resources offered, according to some embodiments. Resource rating and collection of feedback provide insights of learner's appreciation of the training material. The rating value and rating count may be used to identify popular and trending resources and recommend them when aligned with the learning objectives. Also, correlative analytics can be applied to resource ratings, resource usage, and assessment results to identify resources that may be more effective than others.

Gamification—the gamification graphical user interface relies on custom scoring algorithms that track skills competencies and performance as learners matriculate through the gamification platform. This custom scoring system increases motivation and engagement as learners earn badges, points, and tangible rewards. Further, customized real-time leaderboards foster competition among learners, peers, and functional groups.

In some embodiments, the gamification platform also includes a Spaced Repetition Schedule “Recharging” component. The SRS system overcomes learning decay by delivering automated skills recharges with a unique time base algorithm, quiz outcomes and rewards with mastery levels. The system can deliver a spaced repetition schedule to optimize learner retention. The schedule can be configured based on subject matter, retention requirements, and “learned information” (from analytics) about which SRS schedules are effective and which need to be adjusted.

The gamification platform transforms existing client on demand training courses into competency badges, skills tokens, and real-time experiential labs. Through the gamification platform, enterprise learners achieve skills mastery more efficiently while client learning and development (L&D) administrators enjoy granular visibility into learning resource usage, earned competencies, and predictive skills behaviors.

The gamification platform enables a user or client to gamify client skills, provide learning resources, assessment, and certification in order to unleash new potential across enterprise organizations. Currently, there exist issues in training employees due to poor skills acquisition, low learning resource consumption, and poor behavior visibility across enterprise organizations.

The gamification platform of the present disclosures addresses these issues by creating a “Gamification Layer” to motivate learners and streamline the process of navigating and completing learning resources and assessments. This gamification is driven by a “Remediation Matrix,” a remediated learning methodology that gives each learner a personalized learning path to acquire their specific skills and competencies.

The gamification platform of the present disclosure may be configured to ingest any training courses or set of courses existing by a client, such as a human resources department of a major corporation, a new hire training department, a class with a teaching curriculum at a university, and the like. The gamification platform may then be configured to integrate the existing training courses into an immerse program that provides varied levels of achievement and interaction, and generally provides more incentive for a user to want to proceed through the training courses. Further, the platform tracks user performance in the system and provides heuristic reports to improve the effectiveness of the immerse program.

The gamification solution is supported by an immersive storyline that engages learners and motivates them to collaborate with each other and participate more actively in their own skills development. The proposed storyline for each client is taken from today's global headlines, in some embodiments. One such example places the learner within “Cobalt,” an elite cyber-security unit that has been tasked to travel the globe to track down and apprehend a nefarious organization of cyber-criminals known as “Oblivion.”

Various unique architecture and functionality of the gamification platform of the present disclosures will be explored in the following five sections:
Gamification Platform Architecture
Gamification Learner Flow
Personalized Learning Plan (Brain Scans and Remediation Matrix)
Experiential Learning Labs (Hands On Mission Quests)
Heuristics, Predictive Analytics, and Scoring

Gamification Platform Architecture

The gamification platform supports the learner's gamified learning progression through skills development, while remaining “de-coupled” from the storyline and game branding, in some embodiments. This will enable the platform to be reused for other client gamification initiatives with different story themes.

The gamification platform is structured to support advanced data analytics and to allow flexibility and extensibility as the gamification system evolves, thus making the game smarter. The game intelligence engine behind the platform is rules-configurable, allowing on-the-fly adjustments to the learner game experience and outcomes.

Gamification Functional Architecture

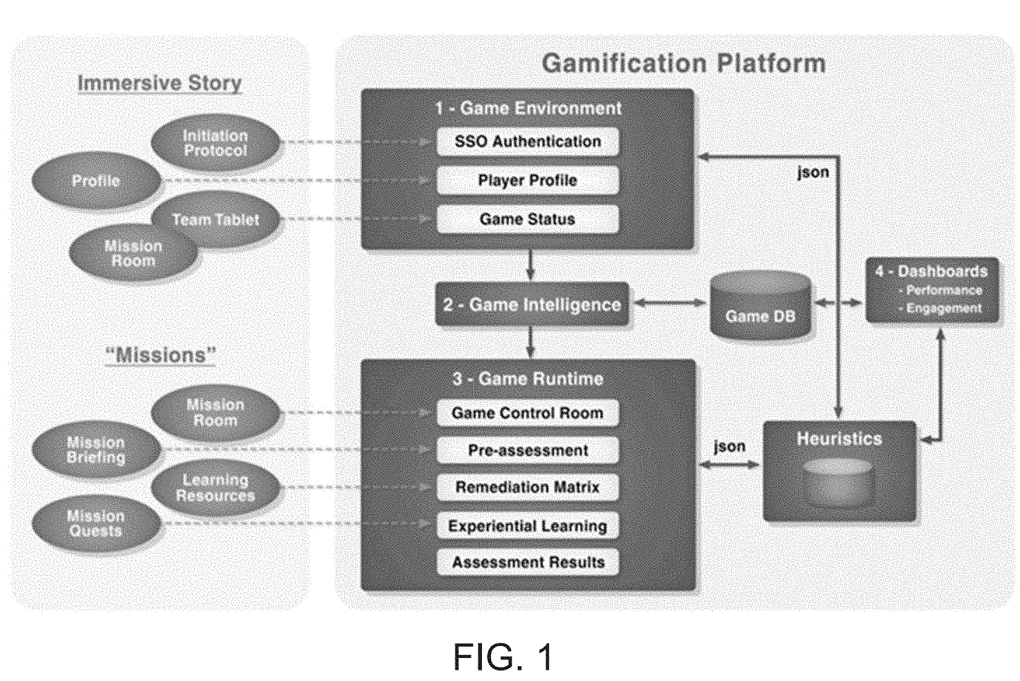

FIG. 1 provides an architectural illustration of the gamification platform and the immersive story layer (Missions), in some embodiments. The following descriptions provide detail on some of the modules shown in FIG. 1.

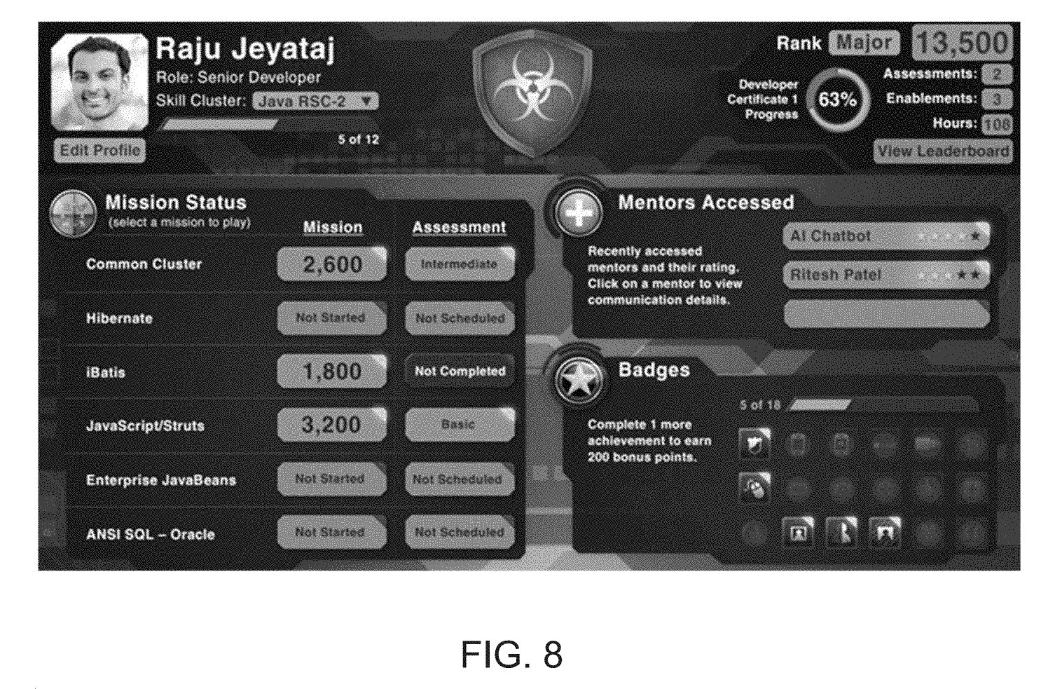

Game Environment—after the game orientation, each learner's skills information and attributes populate their game profile, which is validated against the data analytics model. This authentication utilizes a known list of participants, as well as on demand access for other users. The Game Status screen (see FIG. 8 later) displays each player's game achievements, status of current missions, a mentor access list, and leaderboards.

Game Intelligence—the Game Intelligence Engine launches each mission game with the mission-specific metadata required to access and track the requisite learning resources and experiential labs. This is the analytics engine for tracking learner performance and usage while he/she is in Game Runtime.

Game Runtime—the Game Runtime module displays the assessments, learning resources and labs the learner engages with during each “Mission.” The following are descriptions of the four primary components of each Game Runtime module (mission):

Game Control Room—the skill-specific story interface (“mission room”) highlights the time remaining for the module and retrieves module-specific resources for assessment preparation.

Pre-assessment—the pre-assessment evaluates the learner through a series of questions organized by competencies to identify skills that need remediation.

Remediation Matrix—this prescriptive learning engine offers a series of resources identified for each deficient competency, and re-tests the learner with an assessment before earning competency badges. Also, the Remediation Matrix includes access to help from Client mentors using the Collaboration Panel. Many remediation learning resources have plug-and-play capability, linked from within the game to their location on the client's systems.

Experiential Learning Labs—this capstone exercise is a series of lab steps integrated with an experiential lab environment. Results are tracked and outcomes determine readiness for assessment or the need for more remediation.

Dashboards—data heuristics and analytics are employed to view and filter performance outcomes, degree of learner engagement, and aggregate trends, providing learners and stakeholders with actionable data.

Gamification Engineering Architecture

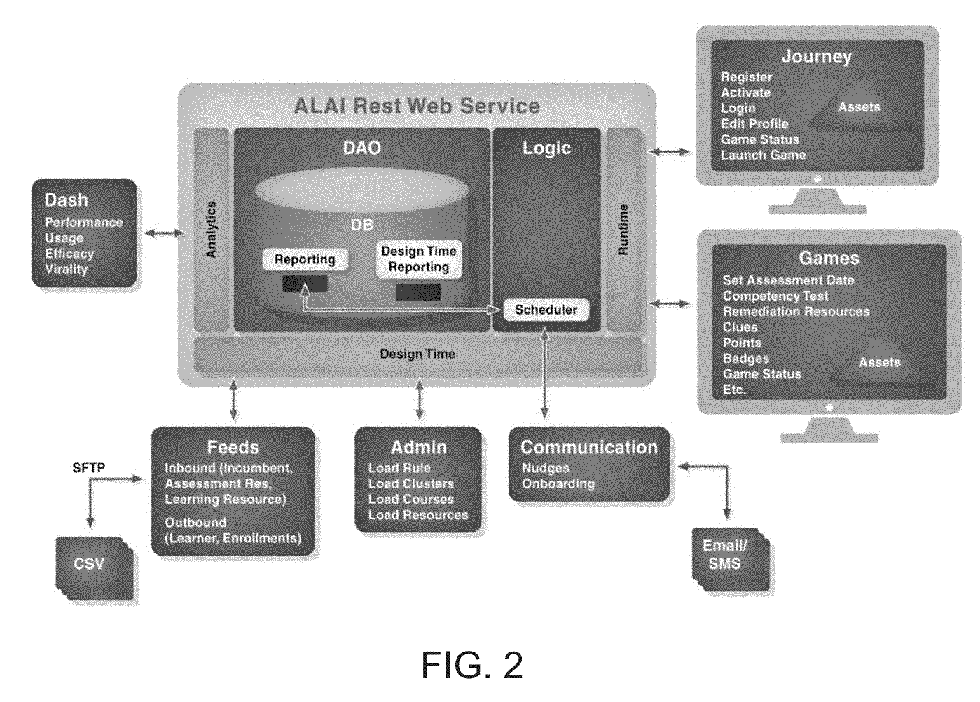

The gamification supporting databases and data models are accessible through REST Web Service APIs, in some embodiments. Refer to FIG. 2 for an illustration of the gamification engineering architecture.

The Collaboration Panel

The gamification integrated Collaboration Panel allows Learners to “connect” with peers, mentors, and subject matter experts with the click of a button via instant message, SMS, voice, or email.

The Collaboration Panel consists of customized communication protocols, software interfaces, and data models that provide real-time collaboration services for peer-to-peer, peer-to-mentor, and group interactions. The Collaboration Panel includes machine-based technology to facilitate instant messaging, voice-over-IP phone calls, email, file transfer, and proactive messaging.

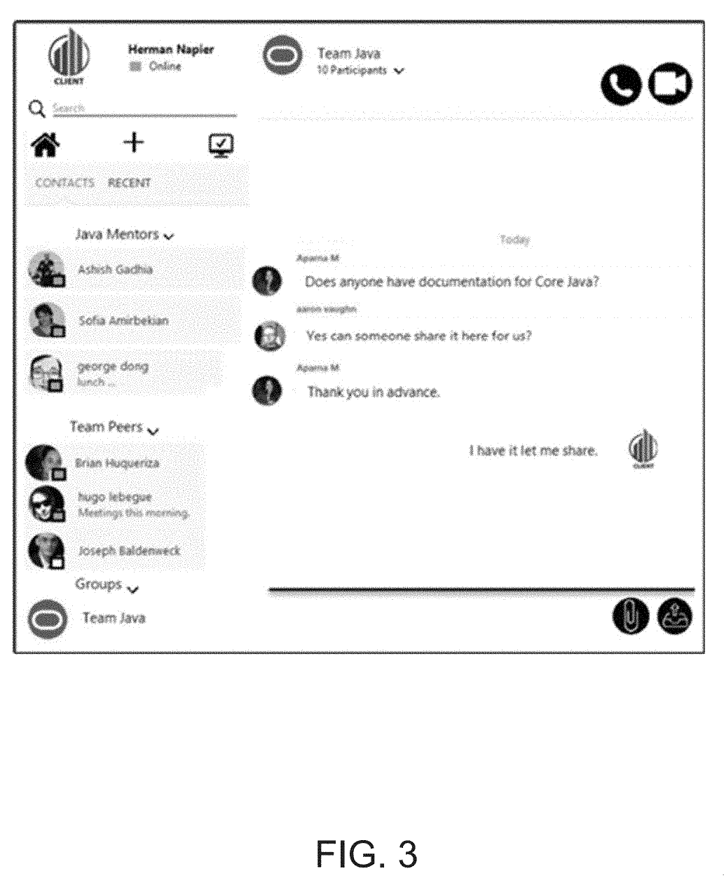

Refer to the FIG. 3 for an example screen capture of the gamification Collaboration Panel.

Additionally, the Collaboration Panel can be activated (upon request) to provide proactive (push) and reactive (pull) messaging to Learners. This level of gamification messaging is called “Nudging.”

Nudging occurs during the on boarding process and within the learning environment. The gamification platform tracks learner progress and skills acquisition in real-time and “nudges” the learner at the appropriate time with motivational and instructional messages. This prescriptive level of collaboration has proven to be very effective in combating learner fatigue and complacency.

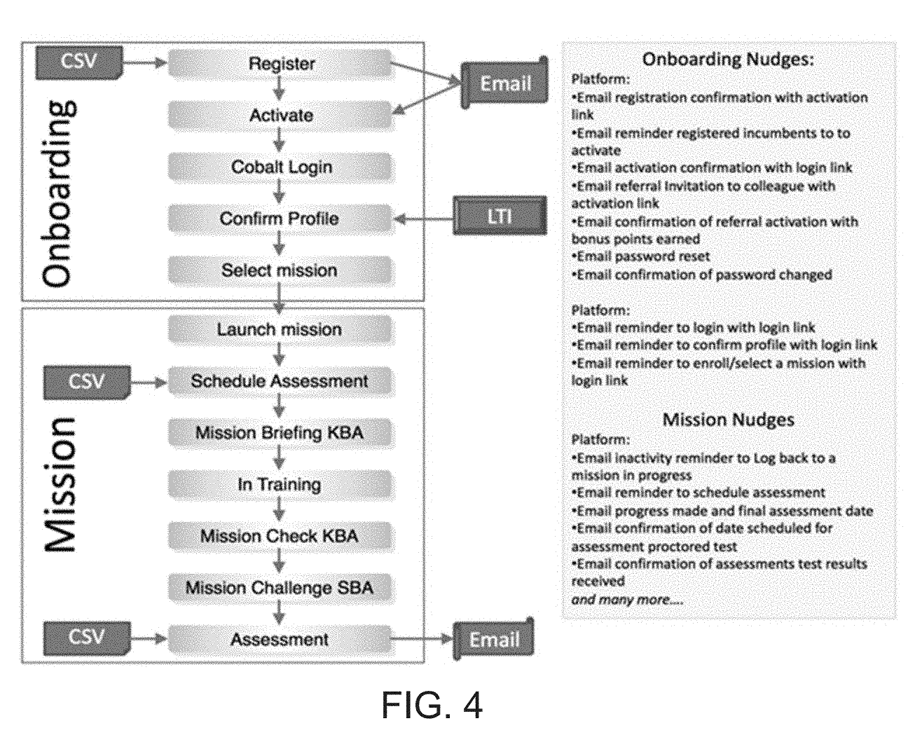

Runtime and analytical data is made accessible through a REST web service API for use by the nudging system, in some embodiments. Refer to the FIG. 4 for an illustration of gamification nudging during mission matriculation.

Gamification Learner Flow

The learner will experience the Gamification Platform as a seamless transition from the client Learning Management System (LMS), via Single Sign-On (SSO). As the learner proceeds through the gamification layer, and each skill mission, updates will be sent to the LMS for events like scheduling the assessment, accessing learning resources, and reporting skill assessment outcomes.

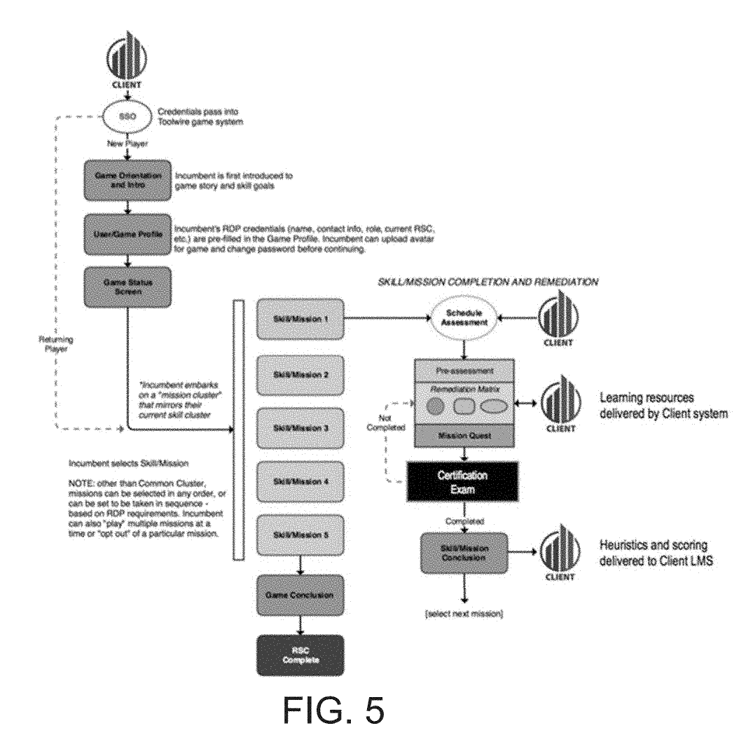

Refer to FIG. 5 for a workflow illustration of the Gamification Learner Flow.

Gamification Game Flow

In some embodiments, on first login, the learner sets his/her password and uploads an avatar image. Passwords can be changed at any time on the Profile screen. The gaming environment then validates that the acquisition of this information complies with the client's security policies, and the learner's email address and mobile phone number are used for Gamification nudges.

The storyline is experienced by each learner as a series of missions—each with its own subplot (like episodes of a TV series) and objectives (finding clues, apprehending agents, stopping attacks, etc.). In some embodiments, each mission begins in the “Mission Room,” the home base for the cyber-threat fighting team. This room has a large world map with advanced technologies and tools, including a computer, mission files, world map, and a clue wall. Each mission will focus on a unique and mysterious story objective.

Below is an example Engineering Schematic for Game Flow:

When the gamification game starts,

Game reads GUID parameter from the tw_integrator.getVar( ). GUID contains email:base64(pwd):role Id: Enrollment id (optional): auth token (optional)

If email is empty, prompt to input email

Check if user exists against ALAI/check [GET]. ALAI responds
plain text

‘OK’ if exists and ready to authenticate,
‘DELETED’ if email has been deleted and need reactivation.
‘NA’ if the account is new and ready to be registered
else AJAX error.
If user doesn't exist or has been deleted, register email
[REGISTRATION],

Retrieve list of roles from ALAI/roles [GET]
prompt to input password
prompt for a profile name
Set role to 1 (CCA)
Register the learner through ALAI/register (POST)
body is a registration JSON
{

email:”dclarke@gamification platform.com”,
profileName: “CLARKE”,
password: “test”,
roleId: 1

}
Inform learner “Activation link has been sent to your email inbox”

Prompt to input password
Game Authenticates against ALAI/authenticate [POST].

On success, ALAI responds plain text with Base64 session token,
On AJAX Error go back to password or prompt for password
recovery
ALAI/resetPassword/{encodedEmail} [GET]
Sends a new password to the learner, learner reads email and
goes back to Prompt to input password

From here, all requests must include the session token in the TWAuthorization header. Also each requests must have the proper Content-Type header; such as application/json plain/text

Game prompts to “Refer a colleague”

If yes, ALAI/v1/rt/referral [POST], body text is colleague email
{
email:”guest@gamification platform.com”,

profileName: “CLARKE”,

password: “test”,
roleId: 1
}
On submit, colleague receives activation link, learner receives
thank you email
When colleague activates, learner receives Congratulation
email +100 bonus points

Get learner profile against ALAI/v1/rt/learner (GET). ALAI returns
current learner profile data
Prompt to input missing learner profile properties (phone, avatar, etc)
Save learner profile against ALAI/v1/rt/learner (POST)
Get main leaderboard ALAI/v1/rt/gamestatus/leaderboard (GET)
Get Learner current Enrollment against
ALAI/v1/rt/enrollments/last (GET)
Get current Learner Clusters against ALAI/v1/rt/clusters (GET)
Enroll learner into a Course ALAI/v1/rt/enrollment [POST]
Get retrieves the mission launch Url ALAI/v1/rt/enrollment/{id}/launchUrl
Game reload at the mission url on launch

Gamification Mission Flow

Each Mission in the story centers on a skill in the learner's current competency cluster. A learner completes the mission when he/she passes the associated skill assessment for that mission. Learners can take the missions in any order and can also take multiple missions at once. This ensures the learner will always stay engaged with the gamification platform.

Learning motivators include curiosity-based story exploration, a countdown clock timer, clues, unlocking tasks, obtaining points, leveling, progress meters, and badges. Badges accumulate across multiple missions and can be redeemed for tangible rewards.

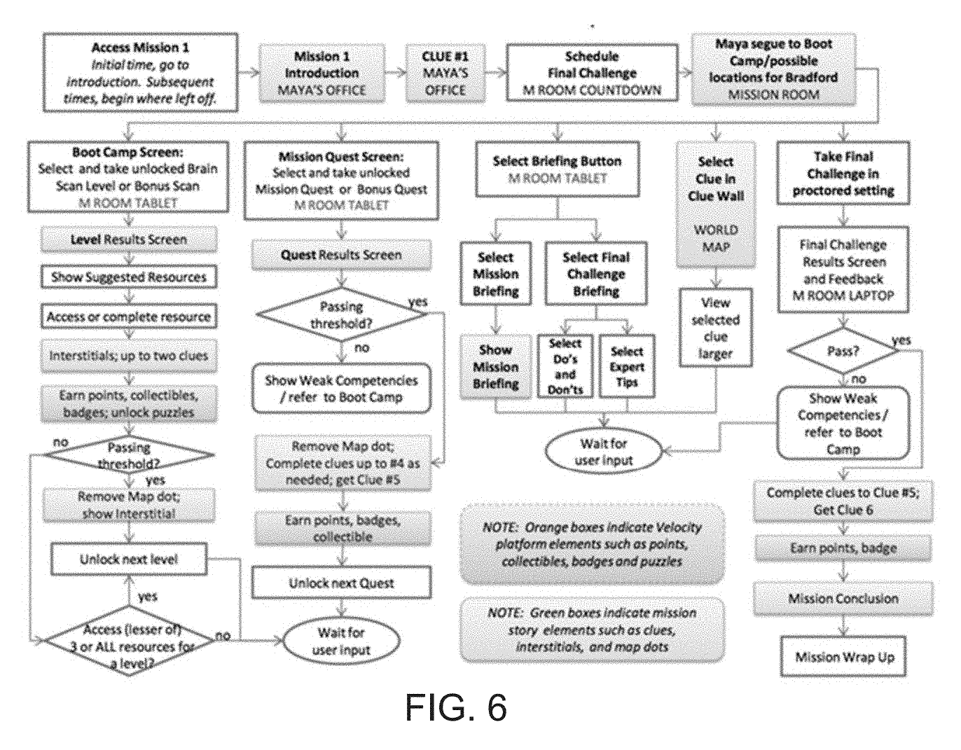

FIG. 6 shows a schematic diagram of an example mission flow in which Bradford, an experienced Cobalt operative, recently went missing. No one has heard from him since. He was searching servers across the globe for stolen source codes, and the search suddenly stopped. It appears that as he grew suspicious that he was being tracked, he intentionally left clues about his anticipated disappearance . . . or demise.

The goal of this mission is simple: locate Bradford. To do this, the learner must pay attention to what's going on around him/her and gather clues as they work their way through this mission. The more proficient the learner is at accomplishing the mission-critical skills competencies (e.g. Java programming), the faster they will find Bradford.

Below is an example Engineering Schematic for Mission Flow:

When the mission starts,

Game reads GUID parameter from the tw_integrator.getVar( ). GUID contains email:base64(pwd):role Id: Enrollment id (optional): auth token (optional)

Mission uses the auth token to continue dialog with the REST APIs. If can't read maintain authentication, mission re-authenticate the learner using email/pwd

For Brain Scan
Use /competencytests to post individual competency test results
Use /enrollments/{enrollmentId}/competencytests? competencyGroup=1 [GET] as query param to pull out all competency test results for group of competencies

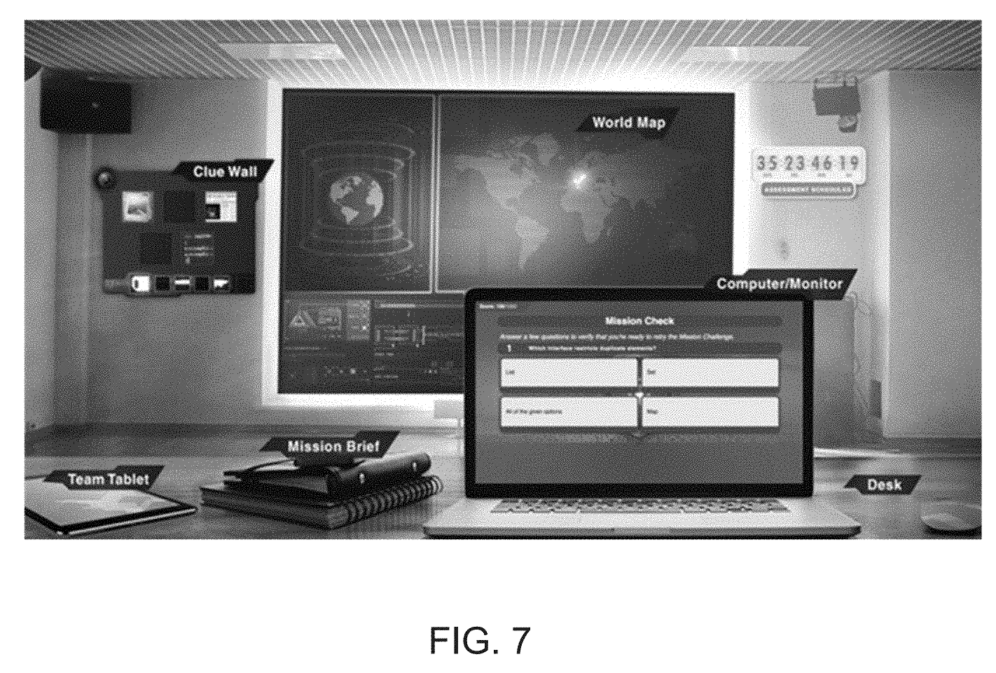

Each Mission begins in a unique “Mission Room” with several mission-specific assets, including an Assessment Countdown Clock, Team Tablet (for mentoring), Clue Wall, Integrated Desktop, and Mission Briefing. See FIG. 7 for an illustration of the Mission Room.

Helping the learner engage with the client training materials and earn specific skills competency badges is the primary focus of each Mission. To this aim, each mission begins with the Mission Briefing—a multiple-choice pre-assessment to test the learner's comprehension of foundational competencies. The learner can “test out” of competencies in the Mission Briefing, but weak competency areas will trigger associated learning resources. These resources are a mix of learning interactions called Mission Tasks, expert videos, and non-interactive digital learning objects (DLOs).

Each story begins with a Program Orientation in which the learner is immersed in the storyline. A story character, portrayed by a professional actor, acts as a video guide to introduce learners to the program and explain the goals and vision of the program. In addition, the guide will explain the importance of assessments to career development and the broad availability of learning resources to help learners earn skills competency badges.

Next, the player is presented with the Game Status screen as shown in FIG. 8.

Table 1 provides an inventory of the assets required for the Game Environment.

TABLE 1
Required Assets for the gamification Game Environment

| | Asset Types |
|---|---|
| COBALT Initiation Protocol | Animation, Video, Interactive Video |
| (Orientation) | |
| Create Cobalt Profile | Web Application, Video |
| (Profile) | |
| Cobalt Status Page | Data Display/Menu, Web Application, |
| (Gamification Status) | Button/Link |
| Mission Room | Graphic, Interactive Graphic, |
| | Web Application, Data Display/ |
| | Menu, Animation, Interaction |
| Leaderboard | Graphic, Data Display |

Gamification Skills Tracking and Competency Flow

The gamification platform guides new learners through the process of selecting the most appropriate set of “skills focus areas” specifically for them. Returning learners may bypass the selection process and be taken straight into their personal dashboard.

Upon reaching a given Skill Cluster, learners will have the option to Enroll (via existing subscription) or Buy Now (to purchase the Skills Cluster independently).

By guiding the learner through the skills selection process, the platform can help align the learner's experience to the appropriate Skills Cluster.

Learners may elect to take the entire Skills Cluster from start to finish or focus on specific competencies of special interest. Either way, learners have the opportunity to demonstrate a level of mastery on specific competencies.

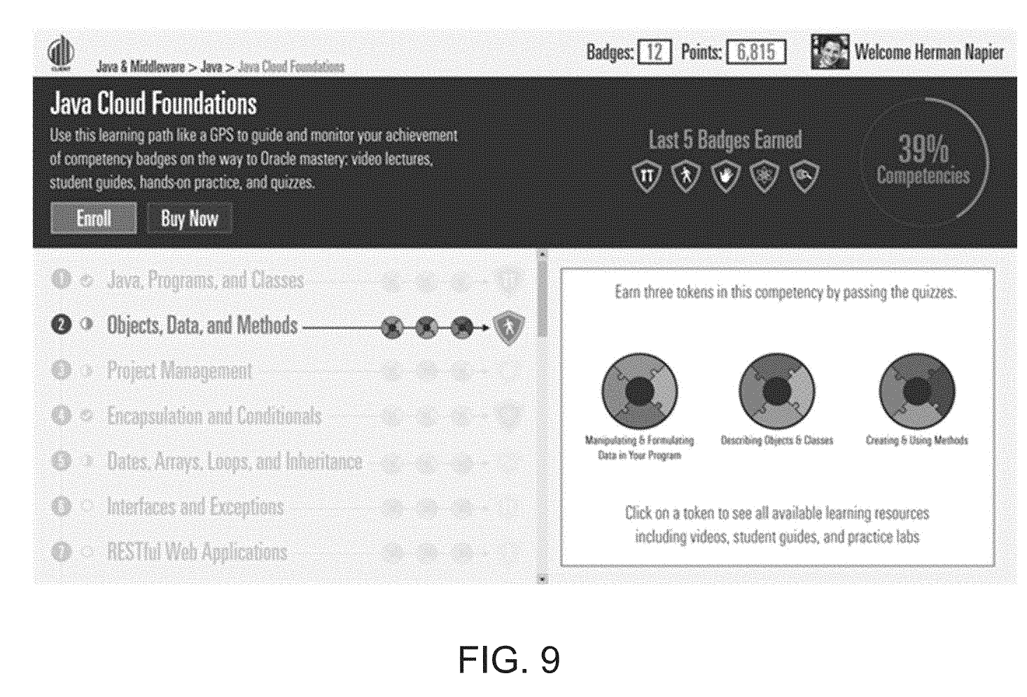

Each Skills Cluster is a collection of competencies from multiple client training courses. In this example, there are 12 Competencies contained within the Java Cloud Foundations Skills Cluster. Refer to FIG. 9.

Each Competency is represented by a “Badge,” and further divided into several “Tokens.” Within a token, there are “Topics,” typically four. In this example, the display shows a learner (Herman Napier) who has completed two competencies (green check marks) and partially completed three others (half-filled orange circles).

Herman's dashboard shows how many badges and points he has earned, the last 5 badges earned, and his percentage of completion for the entire Java Cloud Foundations skills cluster.

Topics can be viewed in any order and quizzes taken at the learner's discretion. An important element of the platform design is to allow the learner to be guided but also to give him/her enough freedom to spend their time as they see best. The quizzes are not mandatory to continue to new content, however, completing the quizzes does aid in demonstrating mastery of a topic and leads to building a learner's badge portfolio.

In this example, Herman selects the competency Objects, Data, and Methods to pick up his learning where he left off. The first token is Manipulating & Formulating Data in Your Program. Herman has successfully completed the four topics that make up this token.

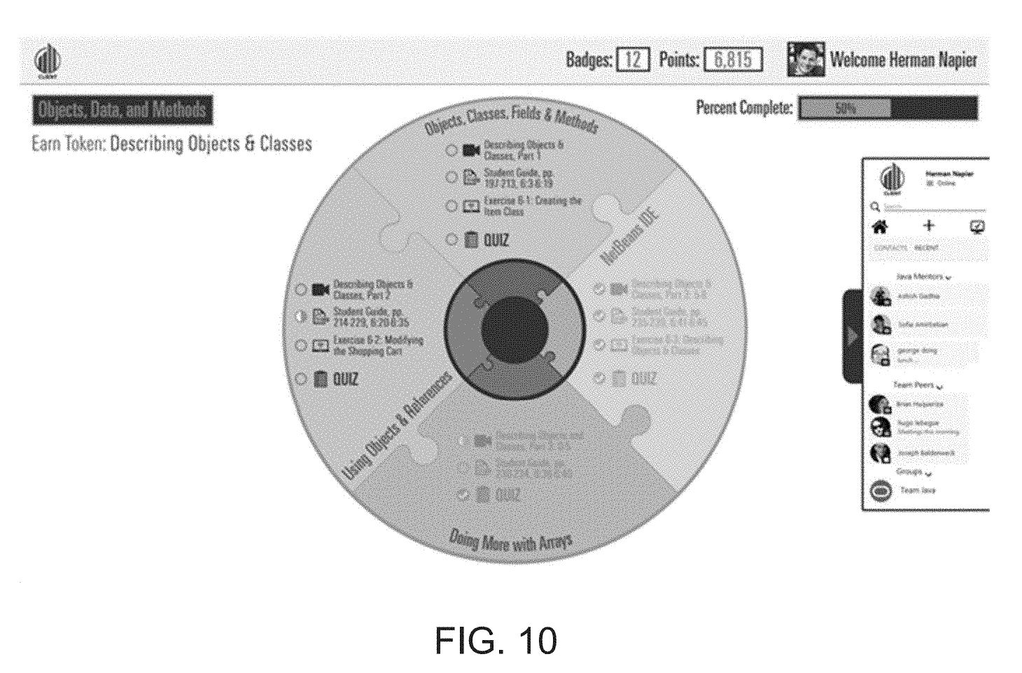

The second token is Describing Objects & Classes. Herman has completed one topic (yellow) and has not started the third—Creating & Using Methods. He clicks on the token to bring up the Token Detail (TD) disc. The “TD” gives Herman a visual of items in each of the four topics that comprise this token (The yellow topic “NetBeans IDE” has been completed). Refer to FIG. 10.

Herman clicks on the green topic Doing More with Arrays and decides to take the quiz before completing all of the learning resources. Herman passes the quiz. The score, points and green topic within the token are automatically updated.

Continuing this example, Herman's group reaches out to him via the Collaboration Panel on the right-side of the screen. He sends the .PDF to his group. Herman selects Objects, Classes, Fields, & Methods and has three items to choose from: Video, Student Guide, and Practice Exercise. He clicks on the Student Guide first and then the video to get specific information pertaining to the topic. During his reading, Herman reaches out to a mentor via the collaboration panel.

Herman clicks on Exercise 6.1 Creating the Class to enter a LiveLab environment. This “OnDemand” desktop allows him to complete his practice exercises in an integrated window. No scheduling is required. Labs are always available. Herman takes the Quiz and passes. Once all of the Topic Quizzes from a particular token have been passed, the learner will earn that Token. When all three tokens are completed, the learners earns the corresponding skills competency badge.

Personalized Learning Plan

The Personalized Learning Plan (PLP) and Remediation Matrix are a collection of proprietary software code that calculates each learner's skills competency gaps using real-time data from pre-assessment exams (called “Brain Scans”). These results are fed into heuristic algorithms in the Remediation Matrix to provide a personalized set of learning resources at the objective level.

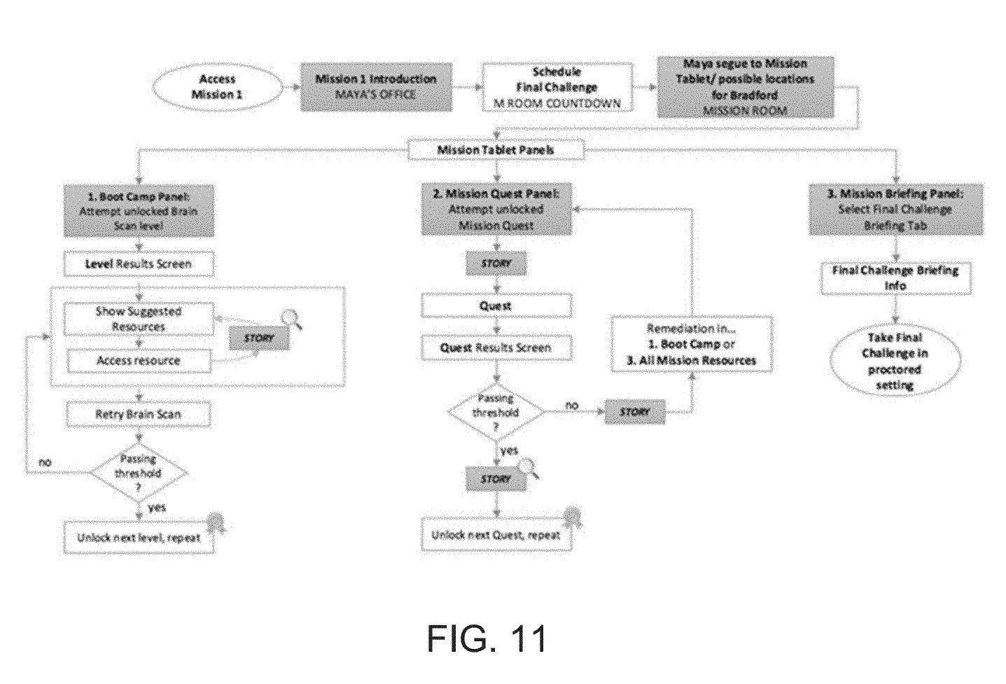

Refer to FIG. 11 for a schematic illustration of the PLP brain scan architecture.

Pre-Assessment “Brain Scans”

In some embodiments, each game mission starts with a pre-assessment. This multiple-choice test evaluates the learner's comprehension of foundational competencies for the target skill.

The “pre-assessment” for the missions will actually be a leveled series of mini-assessments called “Brain Scans.” Each Brain Scan targets 3 competencies and presents a similar mix of questions. The learner takes the first Brain Scan at the beginning of each mission to determine their proficiency in the first three competencies for the targeted assessment. The results of the Brain Scan trigger “Suggested Resources,” a personalized learning path through competency-mapped instructional resources that will help the learner improve upon retry.

If the learner does not score well enough in a competency, their Suggested Resources learning path will include remediation (resources) in that area.

If the learner answers all questions correctly for any particular competency, they have “tested out” of that competency and the Suggested Resources learning path will not include remediation in that area.

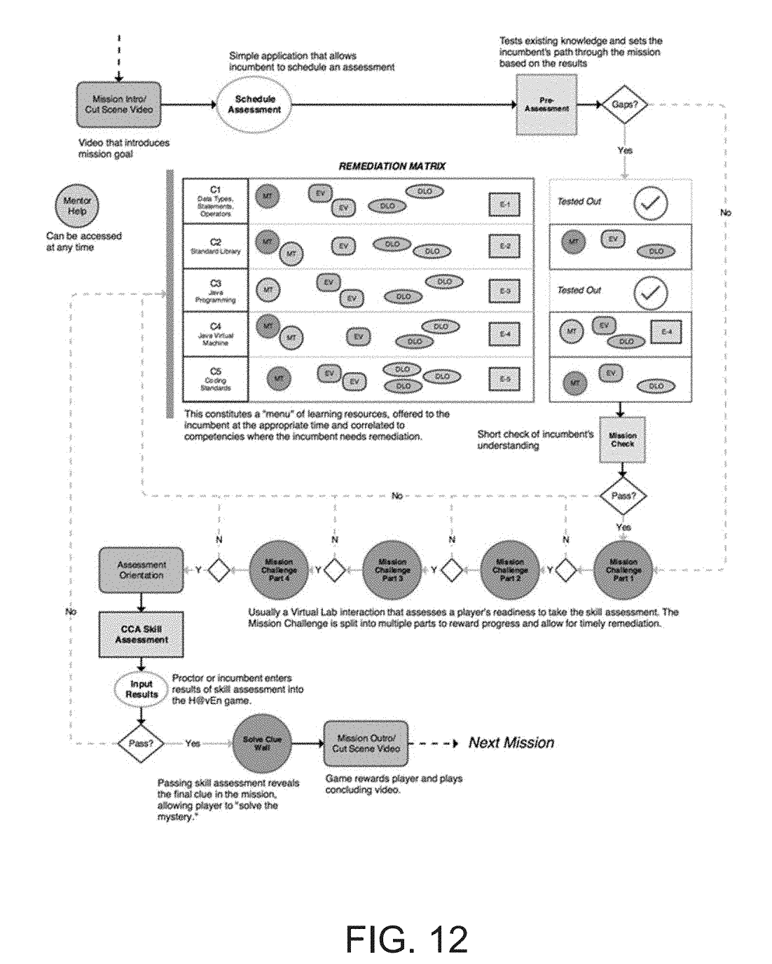

Refer to FIG. 12 for a schematic illustration of the Personalized Learning Plan and Remediation Matrix flow.

The goal of the Brain Scan assessments is to keep them as short as possible while still determining what remediation the learner needs. As such, the target is to target three competencies per Brain Scan level. (E.g., if a mission has 11 competencies, there will be four Brain Scan levels. If it has 18, there will be six.)

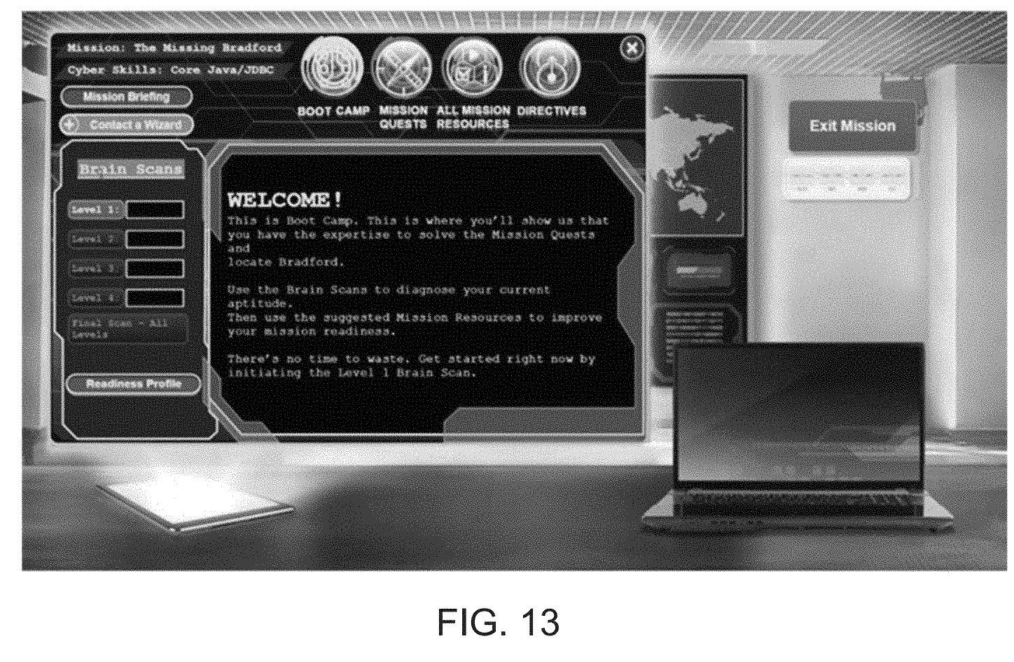

Refer to FIG. 13 for an example screen capture of the Brain Scan interface.

There will be a question bank for each competency from which questions are pulled to populate the test instance. This results in different tests for each learner, since the test items are pulled randomly from the question bank.

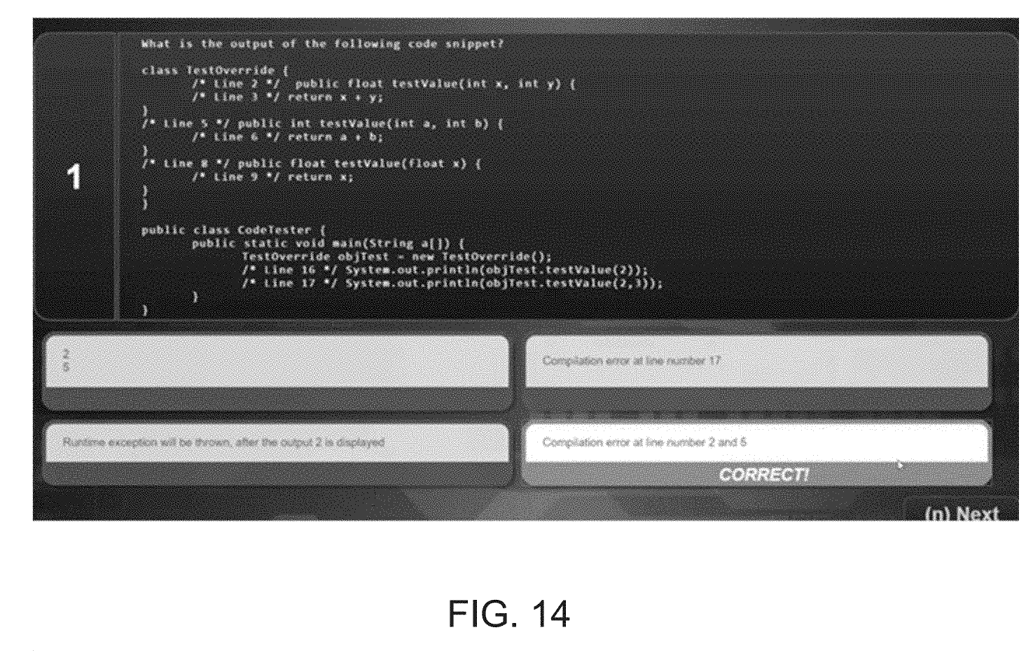

Refer to FIG. 14 for an example screen capture of the Brain Scan item interface.

Brain scan exams are adaptive. When possible, the two questions in the pre-assessment for each competency will include an average question, and a hard question. These two questions are conditional—they are doled out based on correct answers. If the learner correctly answers the first question, they get the second question. If they get the first question wrong, the test “skips” the second question and displays the first question for the next competency Set. If one or both questions for a competency are incorrect, that competency is triggered for remediation.

While the system is designed to be as close to accurate as possible, there are several ways to course-correct as needed:

If the Brain Scan results indicate the learner should remediate (but in truth they are proficient already), they can choose to skip the remediation resources and retry the Brain Scan right away. (Or they can go through the remediation anyway and reinforce their skills.)

If the Brain Scan results indicate the learner is proficient (but in truth they are not), they will most likely fail the associated Mission Quest (the skill-based assessment) for that competency. At that time, they will be directed back to remediation as needed. (Learners must pass the Brain Scans and Mission Quests before being “cleared” to complete the mission).

Remediation Matrix

The results of the pre-assessment are fed into a “Remediation Matrix.” It is a library of learning resources that is used to build a Personalized Learning Plan for each learner. The learner will be guided through the remediation experience by a series of prompts and interactions that address apparent weaknesses and “nudge” the learner to the next needed resource.

When the pre-assessment is complete, a “Readiness Profile” (competency profile) will appear. Each mission may have video or voice-over of a story character reacting to these results. The Readiness Profile gives an overview of learner performance by competency. (It is the same information that is displayed in the learner's Mission Dashboard report.) The screen does not list specific remediation material, that will be listed in the Suggested Resources.

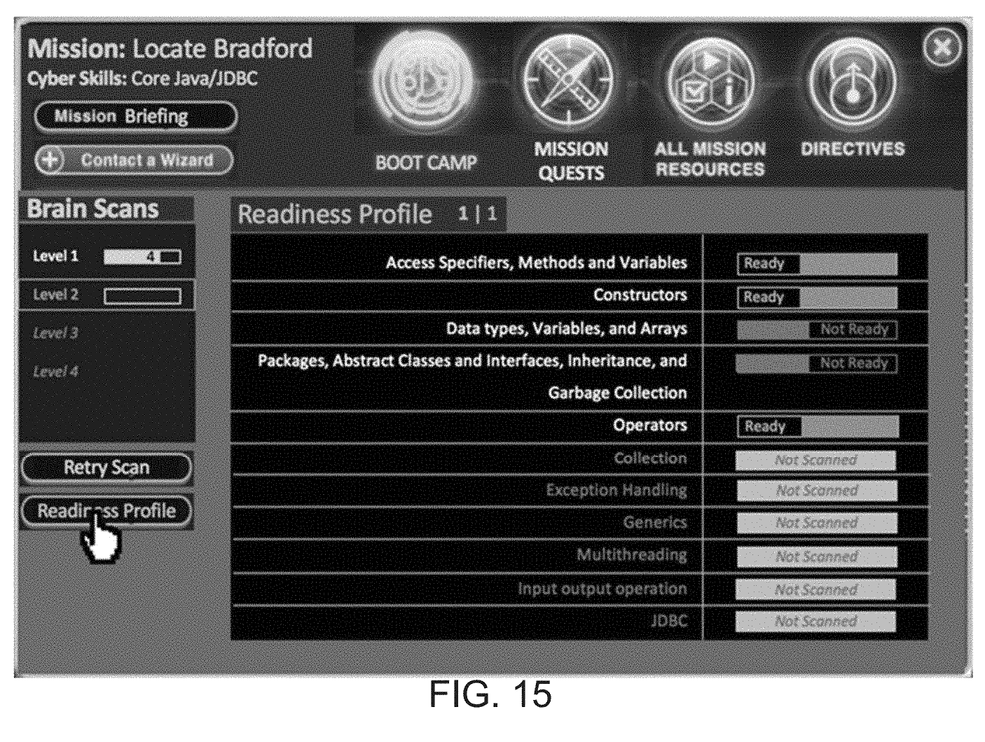

Refer to FIG. 15 for an example screen capture of the Readiness Profile interface.

In the most precise system possible, each remediation resource will cover one competency and be at one difficulty level. However, it is understood that remediation resources may be linked to multiple competencies or to multiple difficulty levels. Each remediation resource is categorized in terms of competency and difficulty level to accurately recommend items based on Brain Scan results. If a remediation resource is for all levels and for all competencies, it would be recommended once within a mission.

Data mining of gamification analytics and performance data from early phases will provide correlation insights into the relative success value of learning resources. This will allow the system to “learn” over time—thus improving personalization, skills transfer efficiency, and first-time competency acquisition.

Suggested Learning Resources

All remediation resources will be delivered from a central repository within the gamification platform. In many cases, the content will be supplied by client and accessed from external locations integrated to the gamification platform.

After the assessment panel minimizes, a Suggested Resources viewer appears in the Brain Scans panel. These are the resources that are triggered for the competencies that were just tested. “Not Started” resources are listed first in the list—any previously completed resources will be at the end of the list so the focus is on what has not been done yet. The player can still access previously completed resources if desired. Information about each resource is displayed below on click, as well as a View button to access the resource. If the Resource has been previously accessed, there will also be a Rate button to give the resource a star rating. (The stars indicate the collective rating learners have given the resource—on a scale from 1 to 3). Player can also click Retry Scan to do the assessment again, or click Readiness Profile to view their current competency status.

If the learner “tests out” of all competencies in a Brain Scan, the Suggested Resources panel is empty and appropriate messaging informs the learner about bonus points earned, new clues, and a prompt to try the next Brain Scan level.

Refer to Table 2 for an example inventory of learning resources required for the gamification Remediation Matrix.

TABLE 2
Remediation Matrix Elements and Required Assets

| | Asset Type | Source |
|---|---|---|
| Mission Task | Interaction | Gamification platform |
| (interactions) | | Client (links to existing |
| | | resources) |
| Expert Video | Video | Gamification platform |
| | | Client (links to existing |
| | | resources) |
| Digital Learning Object | Graphic/Info | Gamification platform |
| (DLO) | Resource | Client (links to existing |
| | | resources) |
| client Skill Learning | Learning | Client (links to existing |
| resource | resource | courses) |
| Mission Check | Assessment | Gamification platform/Client |
| | | (supplies the content) |
| Mission Clue | Multimedia | Gamification platform |
| Nudge | Multimedia | Gamification platform |
| Dynamic Messaging | Messaging | Gamification platform |
| Mentoring Interaction | Mentor Access | Gamification platform |
| | Panel (MAP) | |

Experiential Learning Labs

Research has shown that hands-on practice is the single most important driver in skills and competencies acquisition. Further, as learners prepare to apply their newly acquired knowledge in the workplace, their success largely depends on how much time they spend practicing in a safe, yet real, lab environment.

The experiential learning component of gamification provides access to virtual labs, tracks usage, assesses performance, and provides analytics to client administrators. Also, these “Mission Quests” include integrated lab guides, dynamic remediation, automated scoring, and embedded video.

Experiential Learning Labs Flow

All of the virtual practice labs in the gamified gamification platform provide a seamless flow from the game layer into the virtual software and/or simulation environment. As such, learners are able to access the labs at any time from the game.

From an immersive story perspective, Mission Quests provide a hands-on “capstone” practice exercise to verify the learner's readiness for the workplace. The game layer will transform these case studies into intriguing missions within the game layer and the learners will have the ability to apply their technical skills in a live lab environment.

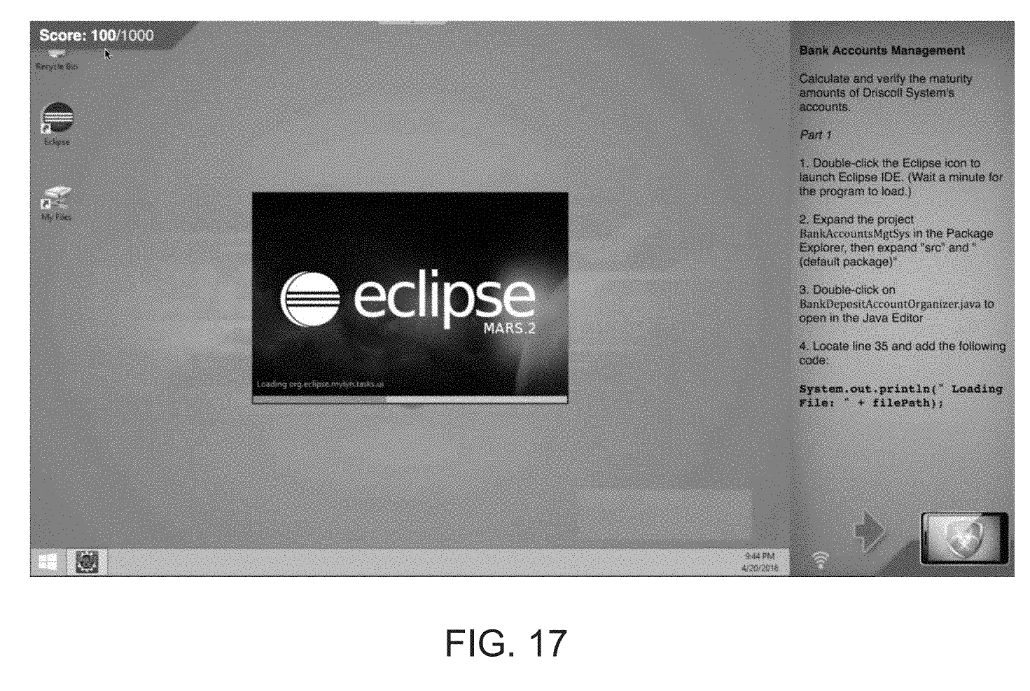

Refer to FIG. 17 for a screen capture of an example experiential learning labs desktop.

In the gamification experiential learning lab environment, learners are provided with as much or as little information as the exercise may require. In some cases, there will be step-by-step instructions on how to work with a particular software application or suite of applications. In other situations, navigating the software might be the challenge itself. Case notes from client manuals dictate the route taken in the mission storyline, along with feedback from the client technical team.

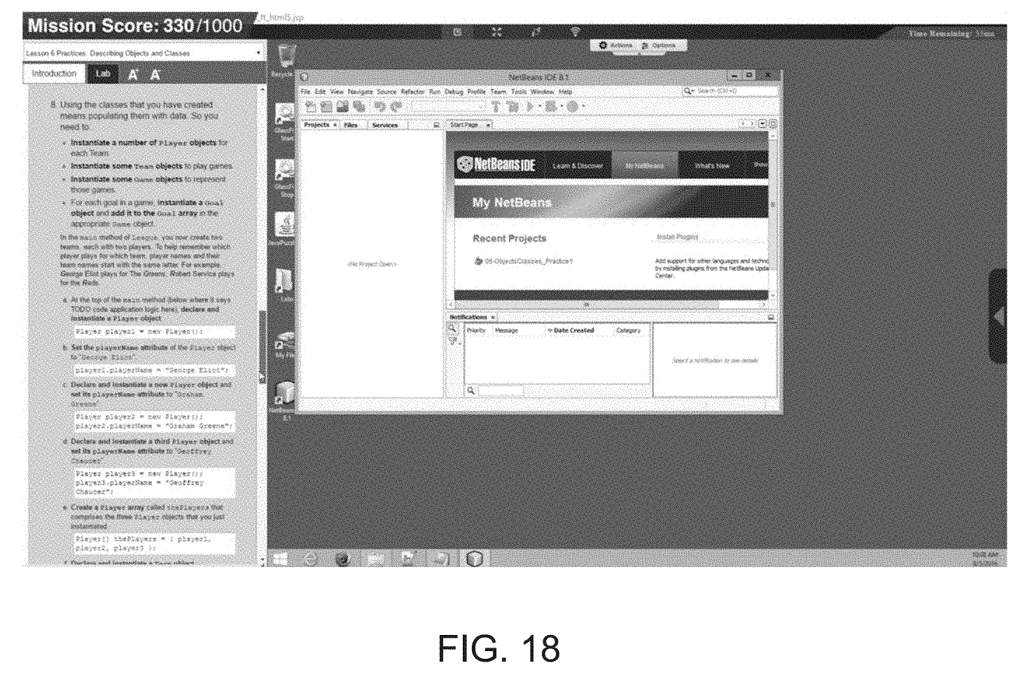

Refer to FIG. 18 for a screen capture of an example experiential learning lab guide frame.

Mission Quests are designed to approximate the hands-on experiential tasks learners will perform in the workplace. As a result, each learner's performance in Mission Quests provide a useful predictor for performance in the workplace. There are typically four Mission Quests per mission.

For each quest, the learner receives one or more coding tasks, the output of which is automatically evaluated by the gamification system and a text or video-based feedback message is displayed based on the result. The messages are concatenated in the same dialogue box but separated by a hard return based on the rules. Checks and Xs are used to indicate which items are correct.

If a given learner successfully completes a Mission Quest, he/she moves on to the next quest. However, if he/she fails, the feedback messaging lists the associated competencies from the gamification data model that need further attention from the automated Remediation Matrix.

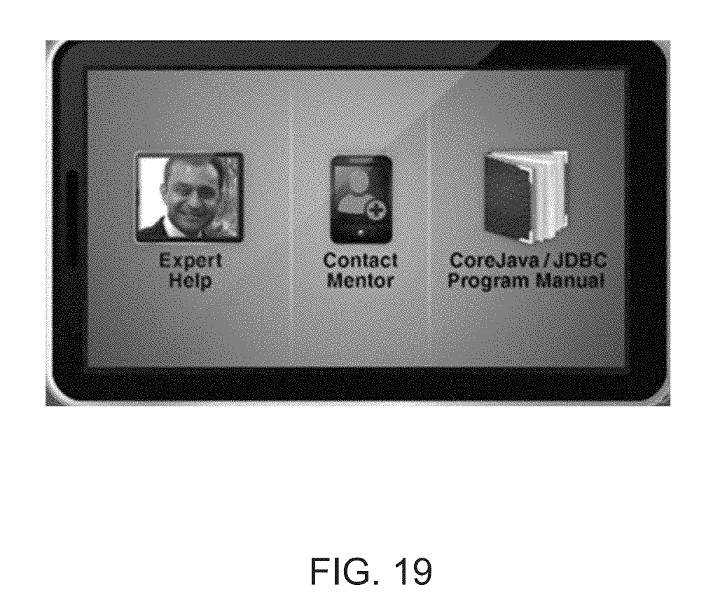

In addition, the gamification platform provides several methods of help and remediation during the Mission Quest, including Expert Help, Mentoring, and Program Manuals. Refer to FIG. 19 for more information.

Experiential Learning Labs Architecture

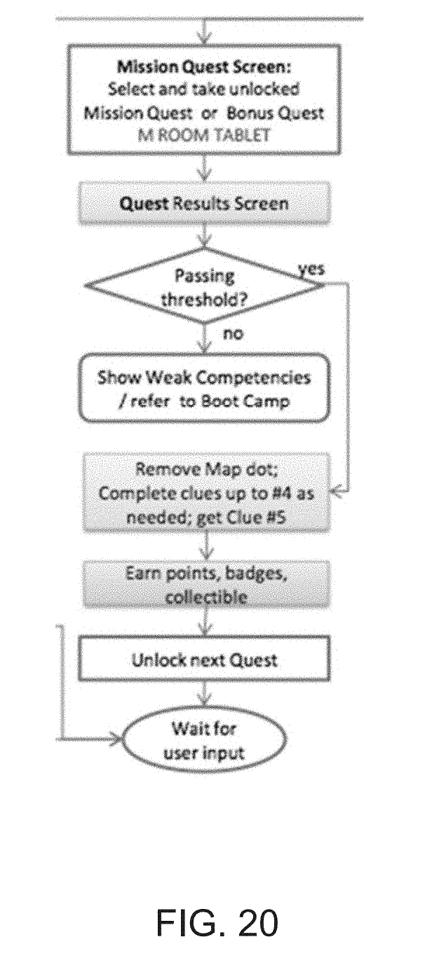

The learner proceeds through Mission Quests as shown in the architecture below. See FIG. 20.

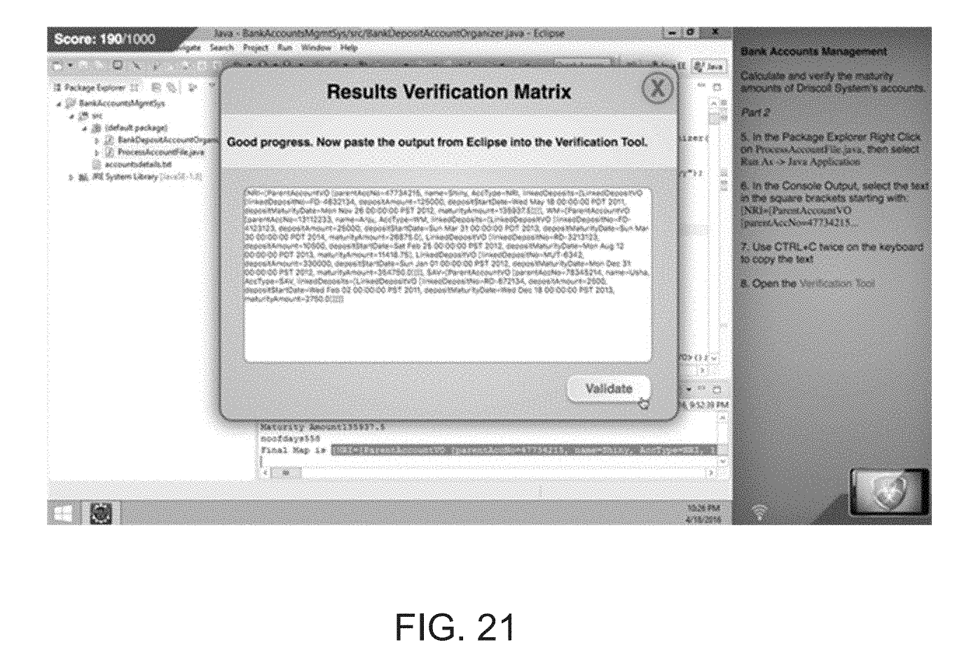

The overall interaction begins with a story-based introduction, followed by an introduction to Quest 1. The Quests must be completed in order—1 through 4. At the conclusion of Quest 1, the learner checks the work output in the Verification Matrix and then receives applicable feedback on his/her performance. Refer to FIG. 21 for an example of a gamification Verification Matrix.

If the performance satisfies the evaluation criteria, the learner can move on to the next Quest (or work on more Brain Scans, Suggested Resources, etc. first if preferred). If the learner doesn't pass the quest, he/she is remediated to the Remediation Matrix to review materials for the applicable competencies.

Learners are evaluated at the conclusion of each Mission Quest. This allows for feedback (and remediation) that helps the learner discover and correct issues right away before continuing on to other Quests. Learners are evaluated based on their role.

Refer to Table 3 for a documentation of the role-based thresholds for passing (“completing”) each Mission Quest.

TABLE 3
Role-based Mission Quest Passing Thresholds

| | | Completion | | |
|---|---|---|---|---|
| Role | SBA % | Status | Skill Level | Action |
| Developer | <40 | Not Completed | Below Basic | Prompt to Remediate |
| | >=40 and <50 | Completed | Basic | Prompt to Continue |
| | >=50 and <60 | Completed | Intermediate | Prompt to Continue |
| | >=60 | Completed | Advanced | Prompt to Continue |
| Sr. | <50 | Not Completed | Basic | Prompt to Remediate |
| Developer | >=50 and <60 | Completed | Intermediate | Prompt to Continue |
| | >=60 | Completed | Advanced | Prompt to Continue |
| Tech | <60 | Not Completed | Basic | Prompt to Remediate |
| Lead | >=60 | Completed | Advanced | Prompt to Continue |

Experiential Learning Labs Performance-Based Assessment

The learner's work for each Mission Quest will be evaluated according to two factors: the code itself and the code output. The code evaluation will count for approximately 70% of the results; the code's output will count for approximately 30%. A default evaluation rubric for these factors is shown in the table below and will be used for the “Verification Matrix” in each Mission Quest. Note that each criteria in the rubric is pass/fail—there is not a “partial” result. Table 4 shows an example verification matrix rubric reflecting example weights for evaluation.

TABLE 4
Verification Matrix Rubric

| | | % | |
|---|---|---|---|
| Factor | Description | Weight | Method |
| Output | Output 1 result matches model | 15 | Pass/Fail |
| | Output 2 result matches model | 15 | Pass/Fail |
| | TOTAL | 30 | |
| Code | Test criteria 1 . . . | 15 | Pass/Fail |
| | Test criteria 2 . . . | 20 | Pass/Fail |
| | Test criteria 3 . . . | 15 | Pass/Fail |
| | Test criteria 4 . . . | 20 | Pass/Fail |
| | TOTAL | 70 | |

Using proprietary software developed for the gamification platform, Mission Quests validate code output. When possible, the platform evaluates the code output by comparing the student's output result with the expected output result in the Verification Matrix.

In addition, the game can evaluate the code itself, by searching for the presence or absence of specific string tokens. Let's take this example:

In Quest 1: Requirement 1, the exercise is about writing a constructor. In Java, a parameterized constructor follows a rigorous coding standard. This is the expected outcome:

//Parameterised Constructor
public OrderDetails (String itemName, float itemCost, int quantity) (

super ( );
this.itemName = itemName;
this.itemCost = itemCost;
this.quantity = quantity;

)

To validate this code, the automated gamification software creates a javascript function executed by the system within the mission and performs grading of the code based on the following rules:
Find the word public
Find the word OrderDetails
Find 2 commas
Find 2 parentheses
Find 3 equal signs
Find the 2 curly brackets
Find at minimum 3 semicolon characters.
Find minimum 1 String, 1 int, and 1 float

This validation routine is included in the game and executed by the Code Validation sub-routine. The platform returns a percentage score (from 0 to 100) that gamification can interpret for display to the learner.

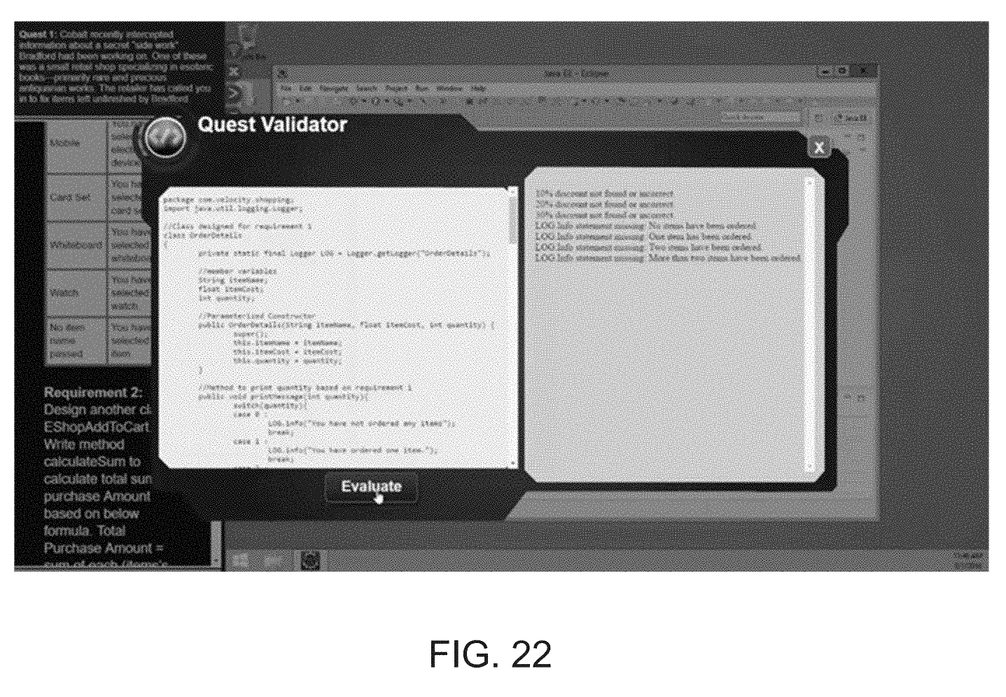

Refer to FIG. 22 for an example screen capture of the Mission Quest Validator.

In this example, each Mission Quest is worth up to 1,500 total game points, divided equally between the four parts of the activity. These game points are earned based on the percentage the learner scores for each part of the quests. Since learners are rated as “advanced” with a 60% or higher result, the game scoring is calibrated accordingly.

Refer to Table 5 for the Mission Quest scoring breakdown.

TABLE 5
Mission Quest Game Points

| Result | Game Points |
|---|---|
| 60% or more | 375 |
| 50-59% | 300 |
| 40-49% | 225 |
| 30-39% | 150 |
| 20-29% | 75 |
| 19% or less | 0 |
| TOTAL (x4 | up to 1,500 |
| Quests) | |

Heuristics, Predictive Analytics, and Scoring

The gamification platform includes data analytics and custom heuristic dashboards to provide client administrators with real-time predictive advice regarding the skills portfolio of their employees and future learning behaviors of individuals, groups, and the organization as a whole.

The gamification Heuristics of the present disclosures derive predictive learning behaviors and discover the quality of skills acquisition from machine algorithms. These machine algorithms are continually improved in real-time using analytical data from hundreds of thousands of learner experiences.

Gamification Heuristics Data Model

The gamification Heuristics data model and dashboards also provide real-time analytics to Learners and stakeholders to answer several questions regarding program success and skills acquisition. In addition, analytics drive intelligence about the relative value of remediation resources and provide guidance for analytics-driven “nudges.”

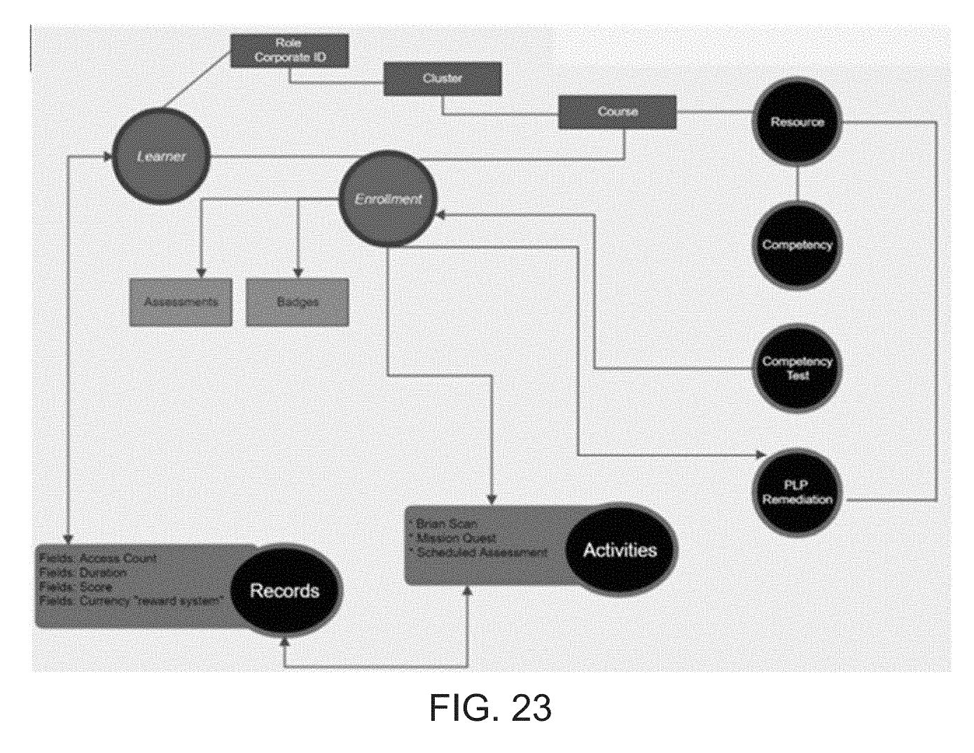

Refer to FIG. 23 for a high-level illustration of the gamification Heuristics data model.

Gamification Heuristic Dashboards

The gamification Heuristics architecture supports custom queries and data mining for specific insights that may arise in the future. Caselets, quizzes, and other game interactions progress the game story and provide feedback to the learner on readiness for a particular skill assessment. The “Mission Dashboard” motivates learners, clarifies their path to certification, and provides a visual measure of achievement.

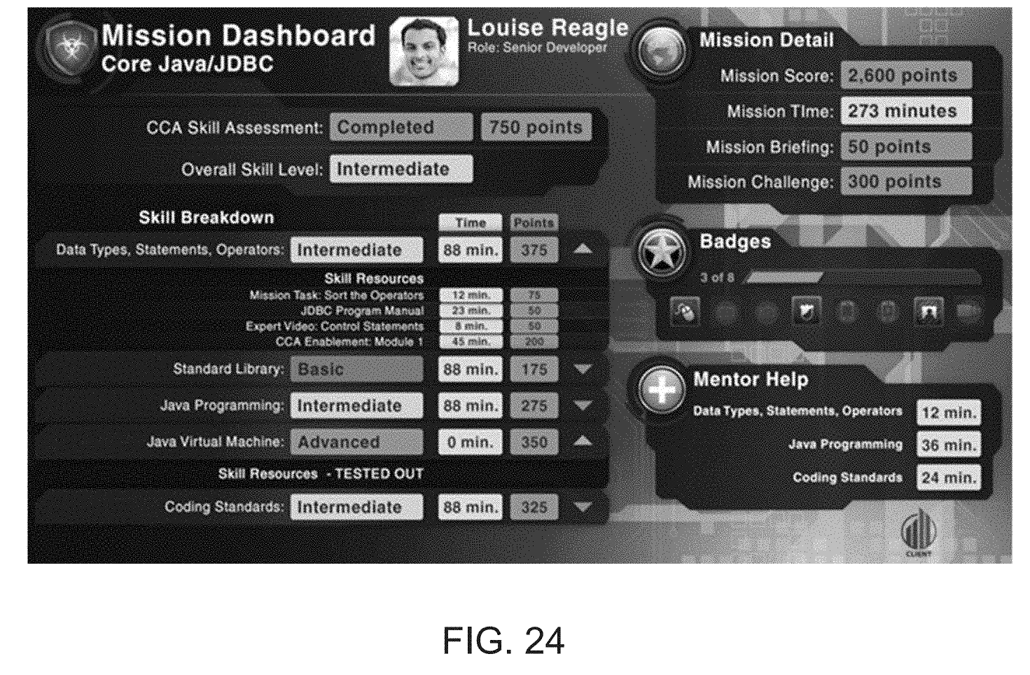

FIG. 24 provides a sample screen capture of a learner's gamification mission dashboard.

The following are a few sample heuristical questions that are answered by the gamification analytics engine of the present disclosures:
1. Is there a correlation between assessment score and resources accessed?
2. Can we determine the relative value of each resource based on the percentage of usage and correlate it to performance by the learner in the assessment?
3. What do the learners think of the dynamic remediation matrix?
4. Are the Dynamic Messaging interactions providing social value? Engagement value?
5. How much time the associates are spending on the platform? What time range are the associates using the platform and when is the peak usage?
6. How has each learner performed in each resource and quiz? How many attempts he/she took to clear the quiz/challenge?

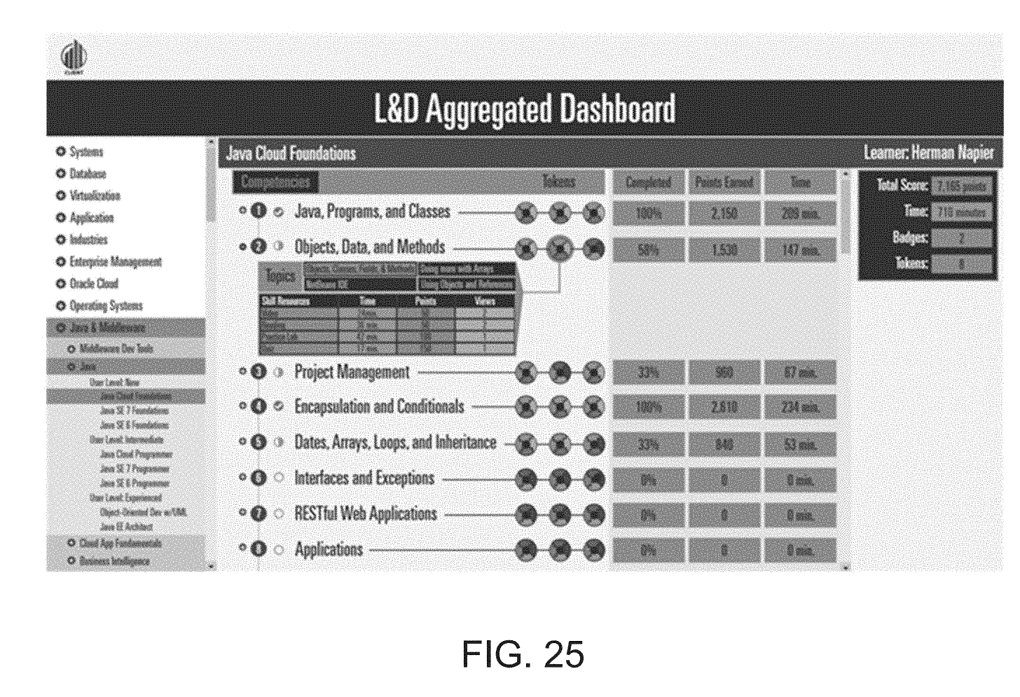

FIG. 25 provides a sample learner dashboard from the gamification analytics engine.

The following are a few sample content focused heuristical questions from the gamification analytics engine of the present disclosures:
1. Where is the learner having problems? And, what have we done to remediate those skills gaps?
2. Did the learner attempt to connect to a Mentor? How many help resources did they access during the mission?
3. How did the group at-large perform on each competency?
4. Can we determine the relative value of each resource based on the percentage of usage and correlate it to performance by the learner in the assessment? This will allow us to make more intelligent decisions about delivering resources in the future.
5. What do the learners think of the Desktop integration? Learning resources?
6. Which of the learning resources are visited more, and which of them are not even visited?
7. What are the early indicators of success? Usage? Mix of resources accessed? Waiting list for rollout? Assessments scheduled and/or passed in a quarter?
8. Which mentors are rated the highest by learners?
9. Are learners queuing to access mentors?
10. Is a specific group or sub-group failing at an alarming rate (greater frequency than the average)?

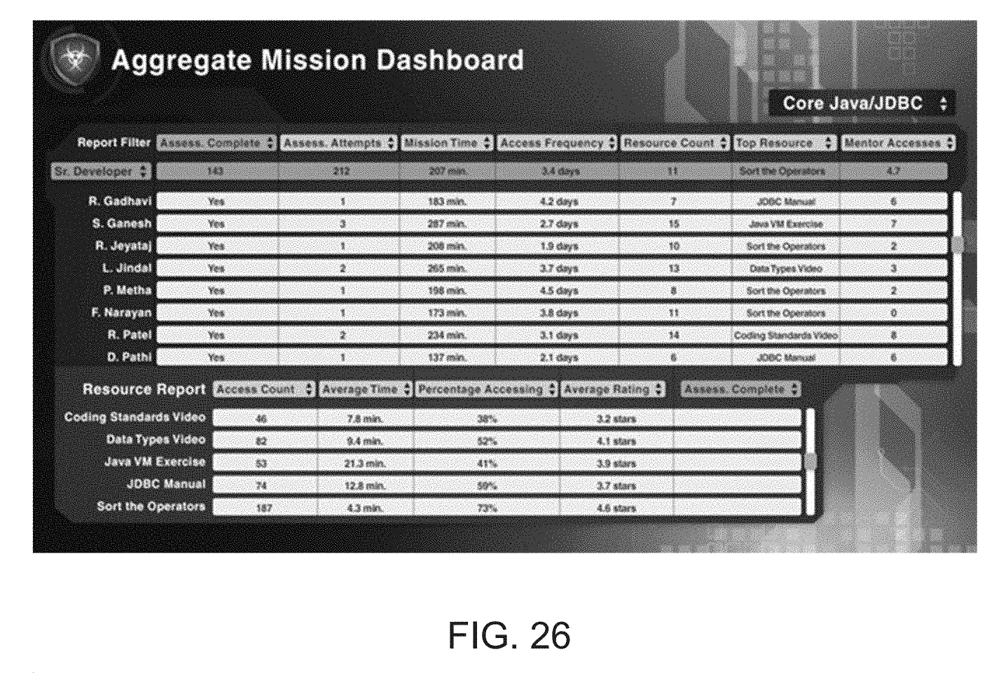

The following are brief descriptions of some possible analytics, as shown in the top half of the Aggregate Mission Dashboard (see FIG. 26).

Using dashboard filters, these sample results are focused on the Core Java/JDBC assessment for Senior Developers. Stakeholders can view the results for each learner (white rows) or the entire population of 212 attempted assessments (blue row).

Assess. Complete—confirmation that the individual learner has passed the assessment. In aggregate, this is the total number of passed assessments to date (143).

Assess. Attempts—the number of attempts the individual learner required before he/she passed the assessment. In aggregate, this is the total number of assessment attempts to date (212).

Mission Time—total minutes an learner spent in the Mission. In aggregate, this is the average amount of time each learner spent in the Mission (207 minutes).

Access Frequency—how often the individual learner accessed the Mission. In aggregate, this is the average frequency for all learners (once every 3.4 days).

Resource Count—total number of learning resources the individual learner accessed via the Mission Remediation Matrix. In aggregate, this is the average number of learning resources accessed by each learner (11).

Top Resource—the highest rated resource for the individual learner or the entire population in aggregate (Sort the Operators). Ratings are determined by each learner.

Mentor Accesses—the number of times each learner accessed a Mentor. In aggregate, it is the average number of Mentor accesses per learner (4.7).

The bottom half of FIG. 26 displays aggregate usage analytics for all Core Java/JDBC learning resources provided in the Remediation Matrix. In the example shown above, the analytics have been filtered for only the 143 completed (passed) assessments. Following are brief descriptions of the sample analytics shown in the bottom half of the Aggregate Mission Dashboard.

Access Count—how many times the population accessed a given learning resource.

Average Time—the average time the population spent using a given learning resource.

Percentage Accessing—the percentage of the population who accessed a given resource.

Average Rating—the average rating (on a scale of 5 stars) for a given learning resource, as determined by learner votes.

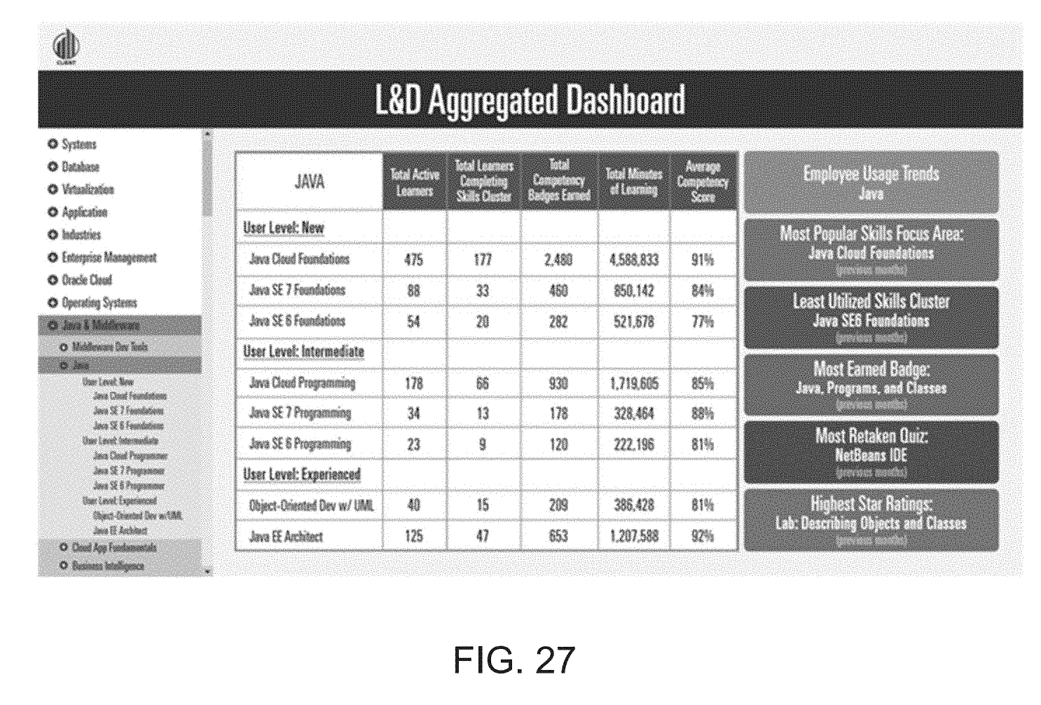

FIG. 27 shows another example of the gamification aggregate dashboard.

Additional metrics can be calculated and displayed in gamification dashboards as needed, such as a learner's relative percentage of performance among the population of learner's who have taken a given assessment. In addition, the overall pass percentage and first-time pass rate per skill can be aggregated on Gamification Dashboards.

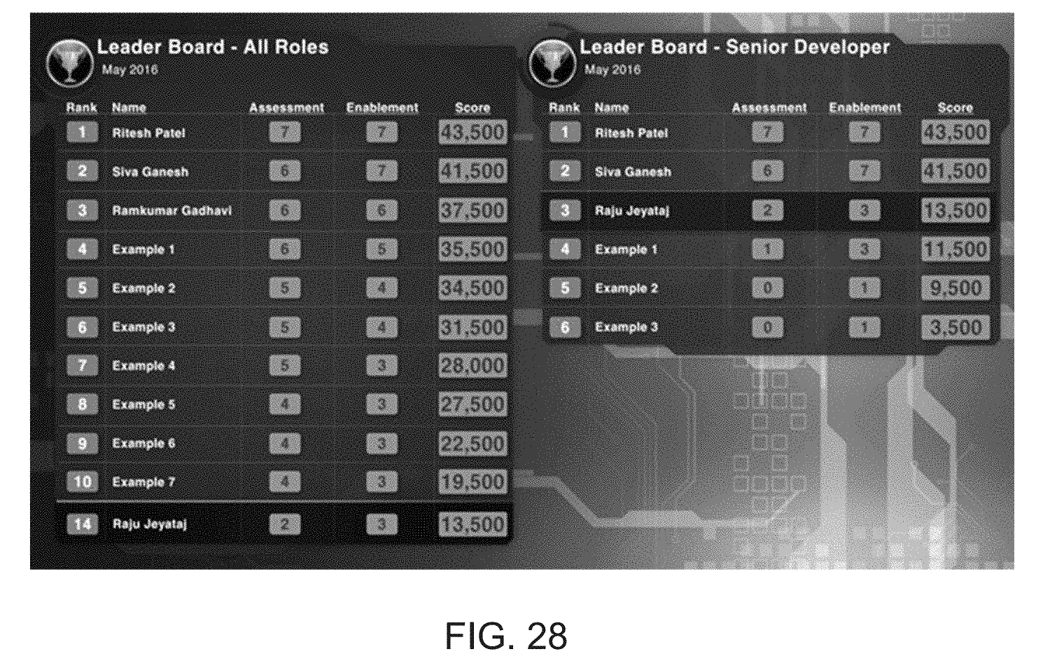

Refer to FIG. 28 for an illustration of the gamification leaderboards.

Refer to Table 6 for an inventory of assets required to launch the skills heuristics and dashboard components.

TABLE 6
Skills Assessment and Dashboards Elements and Required Assets

| | Asset Type | Source |
|---|---|---|
| Assessment Orientation | Video | Gamification platform/ |
| | | Client |
| Assessment Do's | Interactive Graphic | Gamification platform/ |
| and Don'ts | | Client |
| Client Skill Assessment | Assessment | Client |
| Assessment Results | Web Application | Gamification platform |
| Input Form | | |
| Clue Wall Solution | Interactive Graphic | Gamification platform |
| Mission Conclusion | Video | Gamification platform |
| Analytics Dashboard | Data Display | Gamification platform |

The gamification platform continually interacts with a proprietary data system including data analytics and custom heuristic algorithms that calculate the correlation between performance-based and knowledge-based assessments and the utilization of specific learning resources. After data analytics are gathered from thousands of learners, these heuristics inform the predictive software used in the remediation matrix to improve the effectiveness of learning resource recommendations.

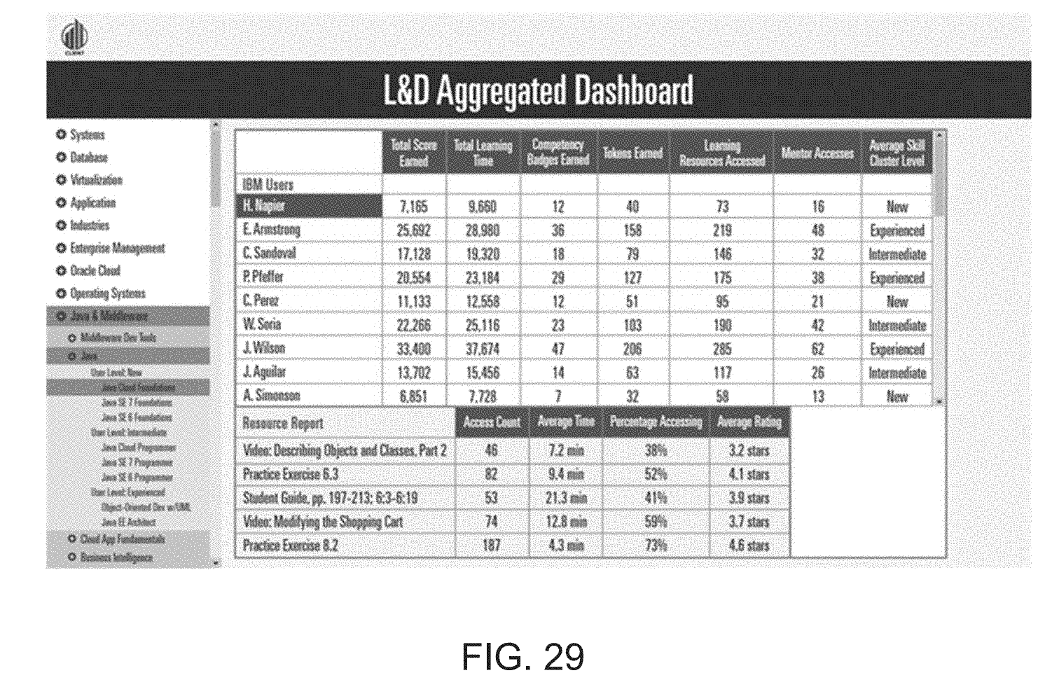

Refer to FIG. 29 for an example resource efficacy heuristics report.

Gamification Scoring

In some embodiments, gamification scoring is based on two point systems:

Competency Points—are awarded for performance in quizzes, assessments and scored interactions like Mission Tasks and Mission Quests.

Experience Points—are awarded for making progress through the game, accessing resources, and so on.

Both point types factor into the total game score.

There is a standard maximum point scale for each mission. Each type of resource, interaction, and assessment has a range of acceptable point values assigned—these can be adjusted to vary the point rewards (surprise factor) and to ensure each mission has the same max point value.

This strategy ensures scoring integrity and true competition as each learner is rewarded for what they do and also prevented from cheating or “gaming” the system.

Table 7 provides a preliminary breakdown of how points are allocated.

TABLE 7
Gamification Scoring Design

| Competency Points | Experience Points (XP) |
|---|---|
| Pre-assessment | Validating/submitting player profile |
| Testing Out (bonus points) | Accessing “easter eggs” during game |
| | orientation |
| Mission Tasks | Starting a mission |
| Mission Checks | Scheduling an assessment |
| | Accessing an enablement, expert video, or |
| | DLO |
| | Accessing a mission task |

Table 8 lists the allocation of points for activities in a typical gamification mission.

| Section | | # of | Points | Points |
|---|---|---|---|---|
| # | Activity/Event | Instances | Per | Possible |
| 2 | Schedule Final Challenge | 1 | 150 | 150 |
| 3 | Brain Scan Level 1 (per question) | 11 | 25 | 275 |
| 3 | Brain Scan Level 2 (per question) | 9 | 25 | 225 |
| 3 | Brain Scan Level 3 (per question) | 10 | 25 | 250 |
| 3 | Brain Scan Level 4 (per question) | 10 | 25 | 250 |
| 3 | Brain Scan Test Out (per competency) | 11 | 45 | 450 |
| 7 | Mission Quest 1 (% tiers) | 1 | 375 | 375 |
| 7 | Mission Quest 2 (% tiers) | 1 | 375 | 375 |
| 7 | Mission Quest 3 (% tiers) | 1 | 375 | 375 |
| 7 | Mission Quest 4 (% tiers) | 1 | 375 | 375 |
| 9 | Final Challenge Attempt/(No Show) | 1 | 500/ | 500/ |
| | | | (−500) | (−500) |
| 9 | Final Challenge Pass | 1 | 2,000 | 2,000 |
| 9 | Bonus - Final Challenge Pass | 1 | 1,500 | 1,500 |
| | on First Attempt | | | |
| 4 | Resource-Mission Task | 8 | Varies | 1,800 |
| | 1. Examine Integer Array | | 150 | |
| | 2. Compare Arrays | | 300 | |
| | 3. Month Class | | 200 | |
| | 4. String Output | | 250 | |
| | 5. Employee Bonus | | 200 | |
| | 6. Print | | 300 | |
| | 7. Count Lines | | 250 | |
| | 8. Print Random Lines | | 150 | |
| 4 | Resource- Mission Guide (client | 9 | Varies | 1,950 |
| | training) | | | |
| | 1. Creating Classes | | 250 | |
| | 2. Working with Classes | | 200 | |
| | 3. Operators and Flow Control | | 200 | |
| | 4. Java Utilities | | 200 | |
| | 5. Exception Handling | | 200 | |
| | 6. Generics and Annotations | | 300 | |
| | 7. Reference Types and Threading | | 250 | |
| | 8. Input Output | | 250 | |
| | 9. JDBC | | 200 | |
| 4 | Resource-Expert Video | 5 | Varies | 550 |
| | 1. Collections Tutorial | | 100 | |
| | 2. Exception Tutorial | | 75 | |
| | 3. Generics Tutorial | | 150 | |
| | 4. I/O Tutorial | | 100 | |
| | 5. JDBC Tutorial | | 125 | |
| 4 | Resource-Mission Aid | 11 | Varies | 630 |
| | 1. Access Specifiers/Modifiers | | 30 | |
| | 2. Garbage Collection | | 60 | |
| | 3. Abstract Class and Interface | | 90 | |
| | 4. Thread Class and Runnable Interface | | 30 | |
| | 5. Operators | | 60 | |
| | 6. Collection | | 60 | |
| | 7. Exception Handling | | 30 | |
| | 8. Generics - Type Parameter | | 60 | |
| | Naming Conventions | | | |
| | 9. Multi-Threading - Life Cycle | | 90 | |
| | of a Thread | | | |
| | 10. I/O Operations | | 30 | |
| | 11. JDBC | | 60 | |
| | TOTALS | | | 12,000 |
| | Bonus Points | | | |
| 3 | “Final Brain Scan” - | 40 | 25 | 1,000 |
| | All Levels (Per Question) | | | |
| 7 | “Bonus Quest 1” (Pass) | 1 | 250 | 250 |
| 7 | “Bonus Quest 2” (Pass) | 1 | 250 | 250 |
| | BONUS TOTALS | | | 1,500 |

Additional Embodiments for Gamification User Interface

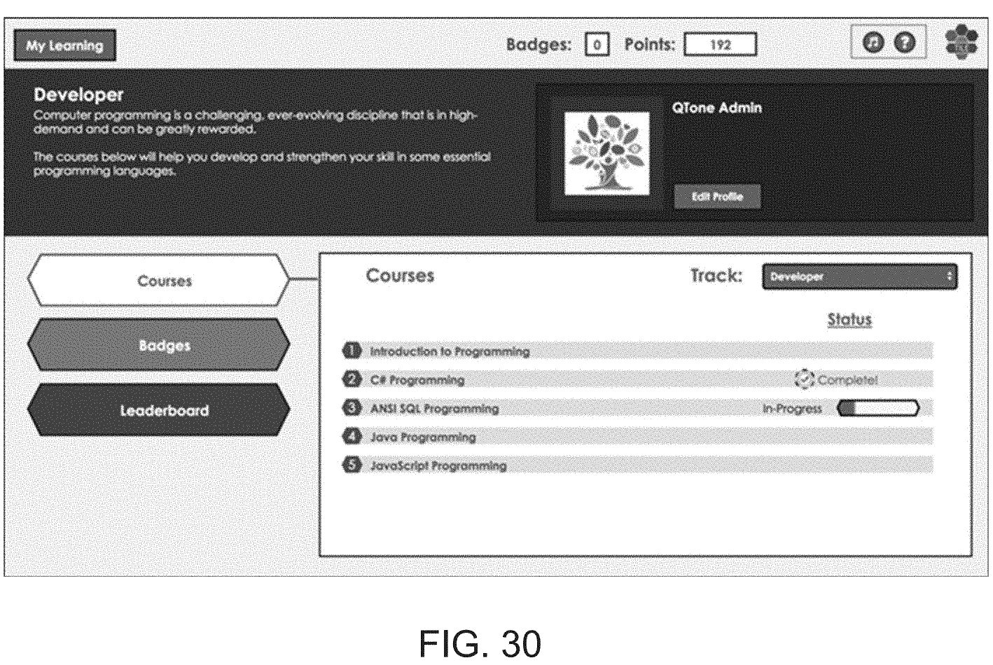

Referring to FIGS. 30-39, in some embodiments, the following example user interfaces are included to enable a user to easily navigate through a gaming environment developed by the gamification platform of the present disclosure.

FIG. 30 shows an example main menu for a gaming environment generated by the gamification platform of the present disclosure, where a user can access the courses that apply to the user's role in the company. The interface makes it simple to track progress in each course and to see what to work on next. Points, badges, and other achievements are easy to see and motivate further learning.

Various features in this interface include Points, Badges panel, Leaderboard, and your Profile. At the top of the screen there is a total game Points, as well as the number of Badges the user has earned.

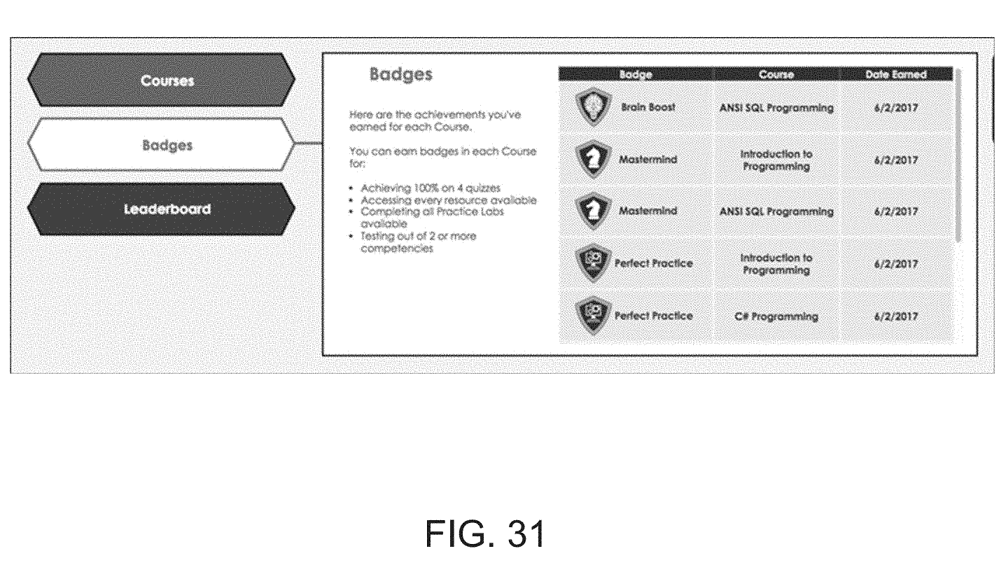

Referring to FIG. 31, after the user selects “Badges,” the badges the user has earned so far may be shown. Badges can be configured for a variety of achievements in the gaming environment, depending on desired outcomes. The badges are based on particular goals met that are based directly on the existing teaching material used to develop the gaming environment, even though such badges and achievements did not exist prior to the development of the gaming environment. In other words, the gamification platform may be configured to analyze the existing teaching material and develop badges that represent particular masteries of the teaching material.

In general, the gaming environment uses social and game-based mechanics to motivate active learning. Overall progress and achievements have high visibility and are shared with peers via the leaderboard.

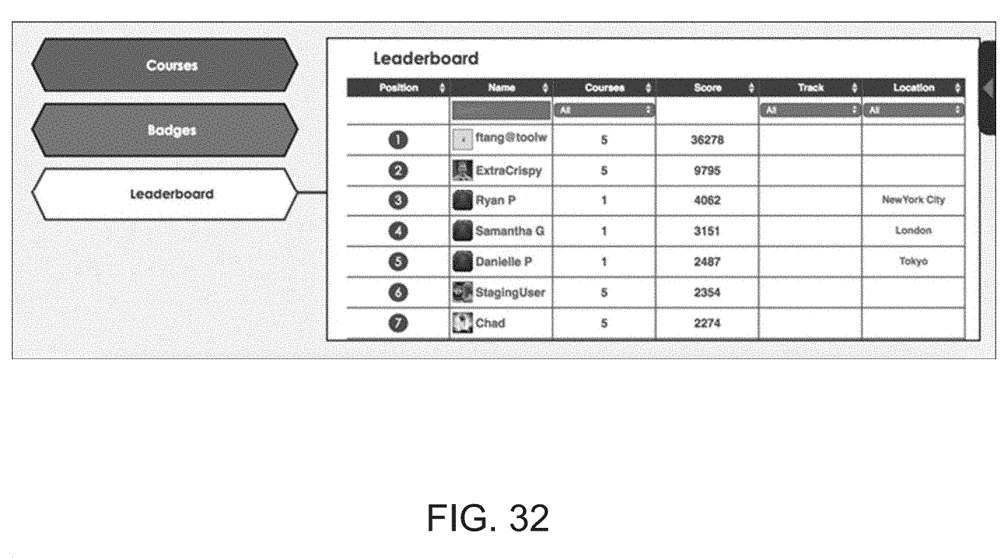

As another example, referring to FIG. 32, the screen “Leaderboard” can be accessed to see how the user compares to other learners in the gaming environment system. If the user is not among the leaders, the user can see his or her current position right below the Top 10. The user can filter and sort the Leaderboard to customize views of the user's peers' performance.

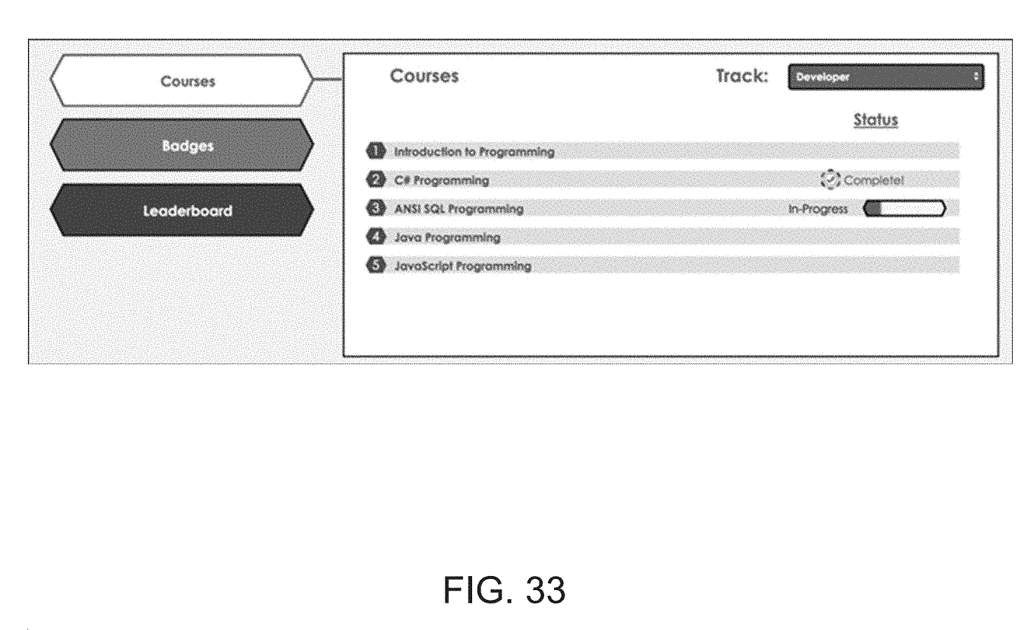

Referring to FIG. 33, the user can also selected “Courses” from the main menu and then select the “Java Programming” course, in this example, as one type of course that can be learned that is introduced into the gaming environment.

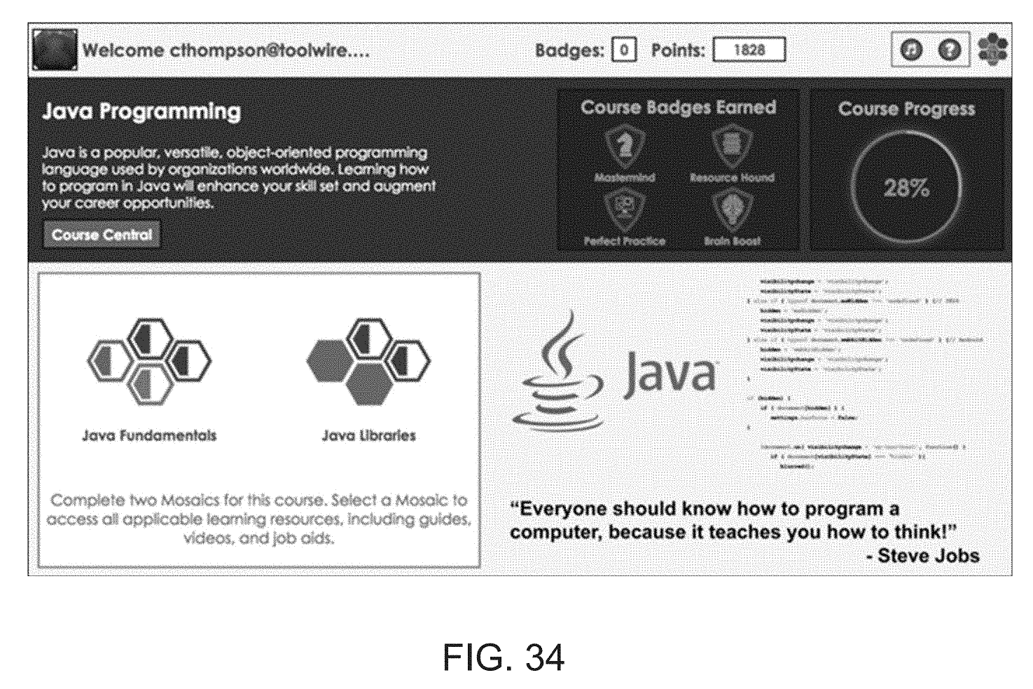

Referring to FIG. 34, shown is a course menu for a particular course accessed from the main menu, such as the Java Programming selection from FIG. 33. In general, in some embodiments, each course has a menu screen with information on the user's competency progress and course badges earned. The platform breaks each course into groups of competencies, displayed as “Mosaics.” These act as signposts, guiding your learning progress and offering a holistic view for each course. This architecture specifically helps to increase confidence and improve usability. An example of a mosaic is the cluster of four hexes above the title “Java Fundamentals.” The user can hover over each badge type to learn how it can be earned.

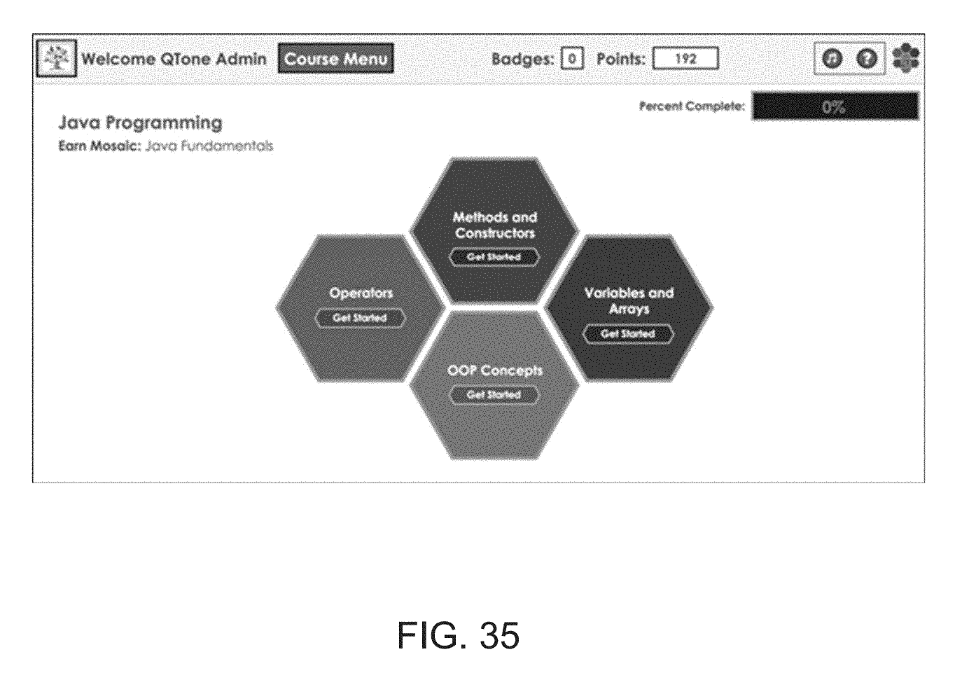

Referring to FIG. 35, after selecting a particular mosaic, in this case the “Java Fundamentals” as an example, the Mosaic screen is accessed. This screen is a focus of the gaming environment learning platform. The Mosaic interface is divided into multiple competency tiles—providing a central access point to learning resources, simulations, virtual labs, and assessments.

This approach “scaffolds” the learning content—supporting learners with a consistent and predictable path to skill acquisition while also adapting to individual abilities and preferences. The associate may access content in a prescribed order or according to individual preference. Quizzes and virtual lab “skill checks” indicate proficiency.

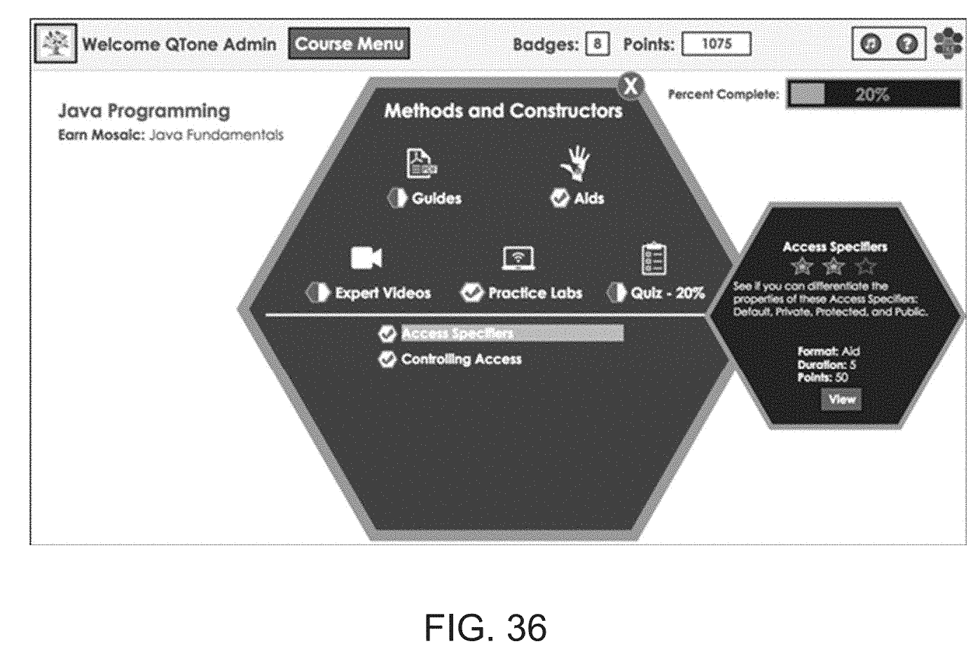

Referring to FIG. 36, from the Mosaic screen, each tile may be selected to explore a particular competency. In this case, the “Methods and Constructors” Tile is selected. A resource menu for the Tile is displayed. Resources for each competency accommodate a variety of learning styles. Guides, Expert Videos, and Job Aids present just in time “Microlearning” content in a variety of media modalities and interactions. Simulations and virtual Practice Labs give the user the opportunity to apply what has been learned in a “safe-to-fail” environment.

The user has the ability to take a quiz to quickly check comprehension of key competency concepts. All of these resources and activities provide opportunities to earn points and badges.

As each resource is attempted, explored, and completed, the user can see various updates taking place on the screen.

Status Icons next to the Resource and Resource Type indicate the user's updated progress.

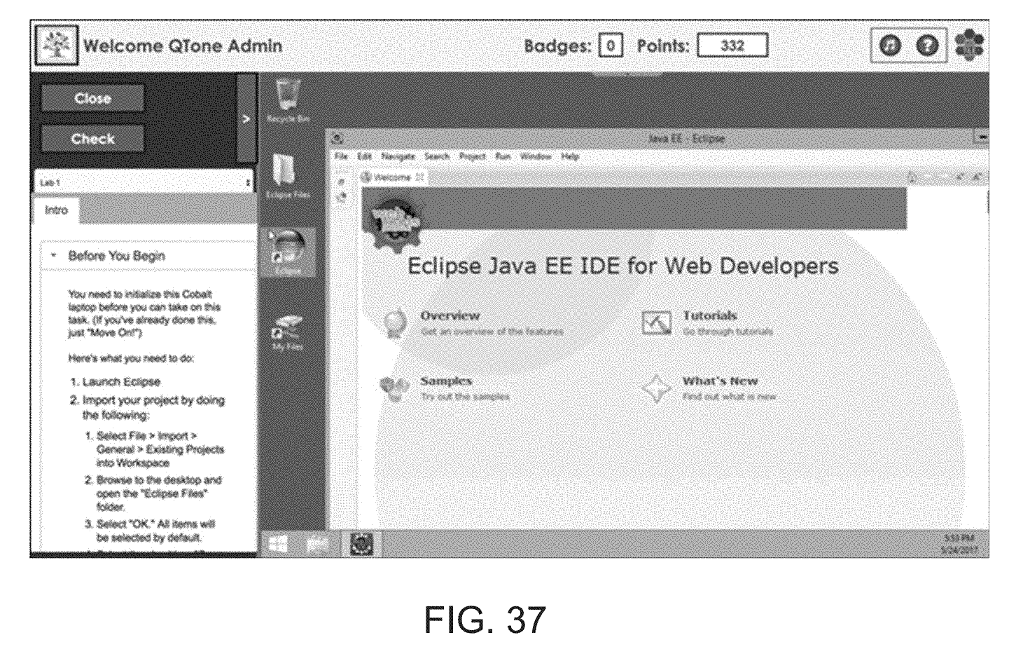

Referring to FIG. 37, shown is a Practice Lab environment to allow the user to gain more hands-on learning of the material. The Practice Lab has two main elements: a “Lab Guide” on the left with instructions and help information, and a virtual computer desktop on the right where you will use actual tools and programs to complete the tasks.

This Practice Lab focuses on using Eclipse Java EE IDE to write programs using Java. The user can follow the instructions in the Lab Guide to complete one or all of the steps.

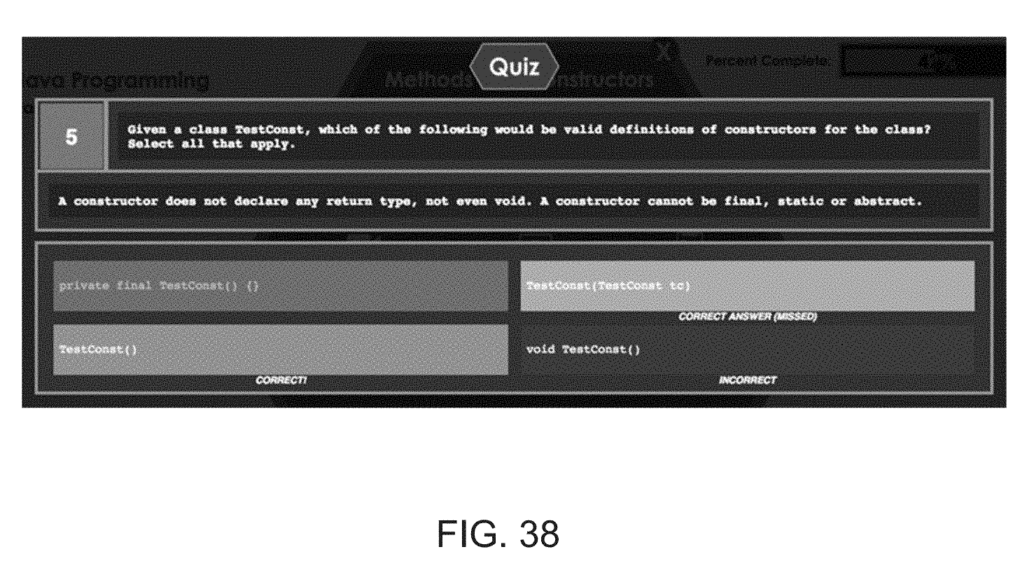

Referring to FIG. 38, once comfortable, the user can access a quiz to test mastery of the subject and to gain an achievement or badge. The user can now try the Quiz to check his or her learning. This example screen shows which answers are correct and incorrect. For incorrect answers, an explanation is displayed to remediate your understanding of the concept. If the user would like help with some answers, the user may use the answer key on the next page.

When the user has completed all the resources and activities in a Tile, all the resource types will be checked and a checkmark will appear on the Tile when it's minimized. All resources in the Tile are still accessible for review.

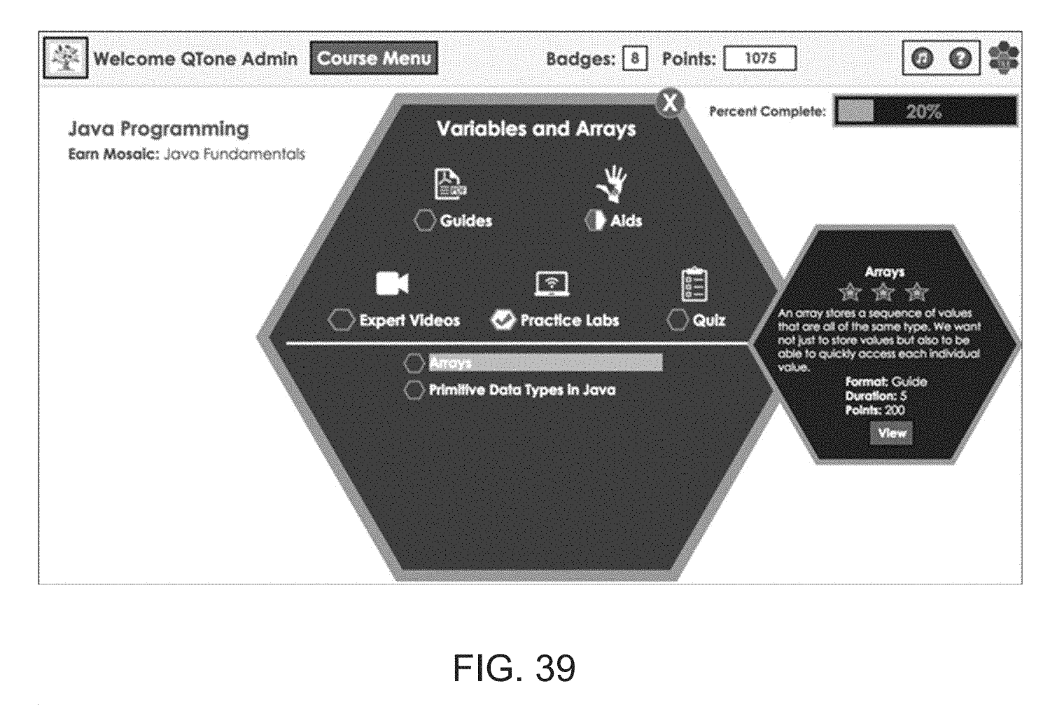

Now that the first Tile is complete, other resources and activities may be explored in the Variables and Arrays Tile. FIG. 39 shows a second Tile related to a slightly different subject matter. This Tile has another advanced Practice Lab, which is a virtual desktop that you can use to tryout the Eclipse Java IDE and get feedback on your competency level in real-time.

Gamification Development Process

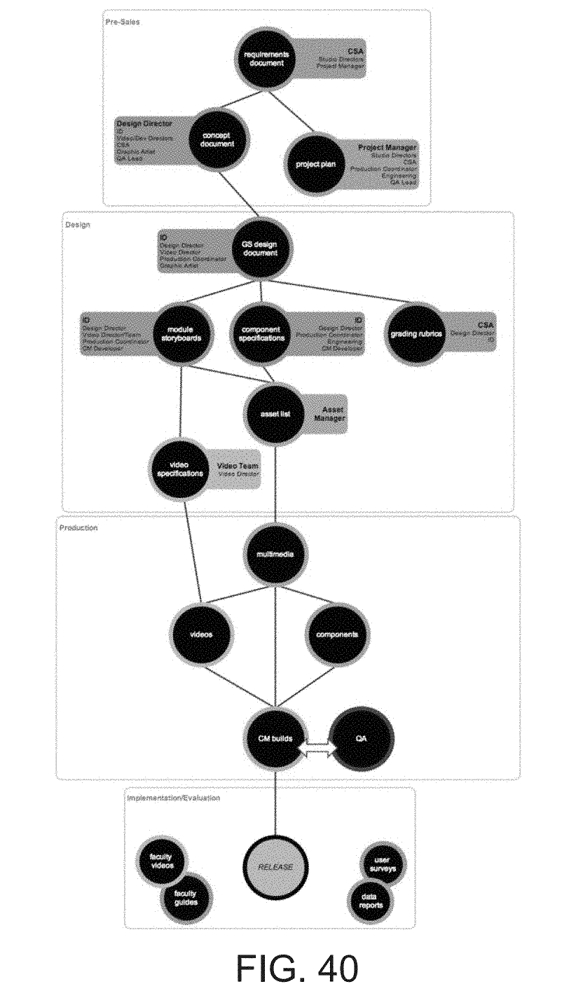

In some embodiments, the gamification platform ingests existing client training materials and transforms them into gamified learner experiences in four development phases. See FIG. 40 for an example illustration of the resources, technical specifications, and assets involved in the gamification development process.

Pre-sales: during the pre-sales phase of the gamification development process, a cross-functional team is created to engage in co-creation solution analysis with the client. Over several meetings, the team identifies the intended audience of the gamified experience, catalogs existing client training materials, and builds a Requirements Document with the client. Then, the cross-functional team develops a Concept Document with high-level design elements for the immersive story, scoring, motivation techniques, and proposed instructional and gamification methodologies. Simultaneously, the Project Manager builds a Project Plan to identify required resources and build a detailed schedule from design through implementation and evaluation.

Design: during the design phase of the gamification development process, Instructional Designers, an Asset Manager, and the Video Team collaborate to build several design specifications and blueprints for transformation of client training materials into gamified learner experiences. These specifications are developed using machine-based templates, best practices, and automated translation routines. The specifications include a Gamification Design Document, Grading Rubric, Module Storyboards, Component Specifications, an Asset List, and Video Specifications.

Production: during the production phase of the gamification development process, proprietary systems and engineering resources transform the design specifications into machine-readable software. This phase includes development of seamless integration protocols for delivery of existing client training materials from within the gamification platform. In addition, the pre-final gamified learner experience is extensively tested by the Quality Assurance (QA) team and client during the production phase.

Implementation/Evaluation: during the implementation/evaluation phase of the gamification development process, the final gamified learner experience is released to learners within the client training ecosystem. User surveys and heuristic data reports are used to evaluate the effectiveness of the solution, and adjustments are made periodically as part of a continuous improvement process.

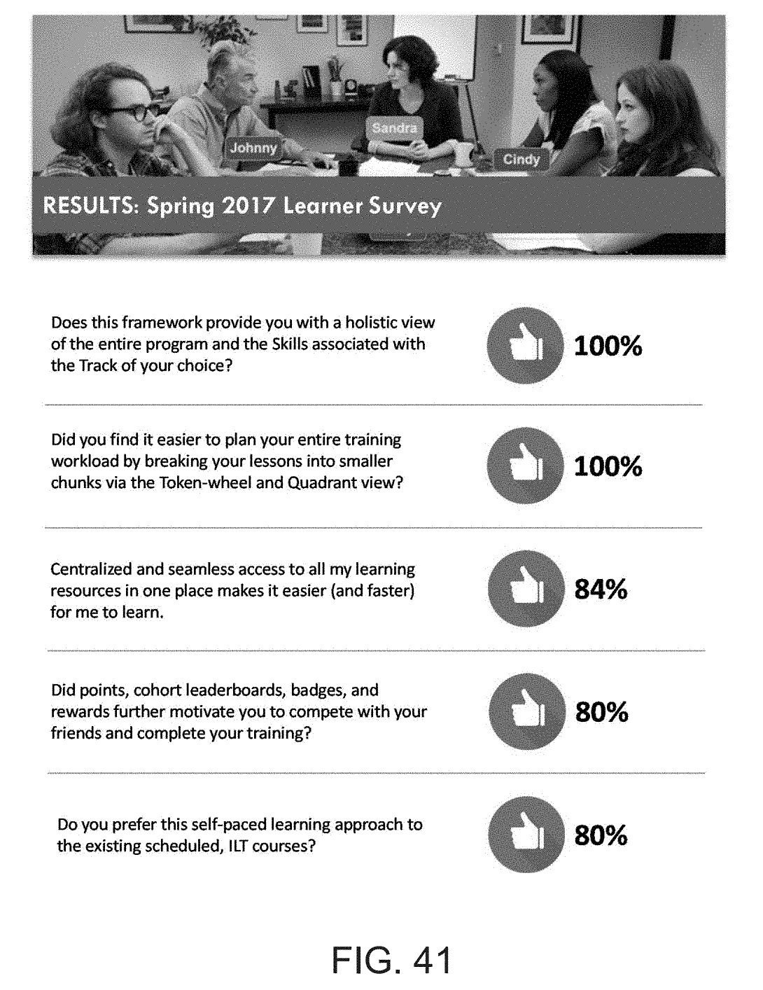

Referring to FIG. 41, the following graphic shows the results of one survey highlighting results from the use of various gaming environments generated by the gamification platform according to the present disclosure. The survey shows how the vast majority of users of the gamification platform found the gaming environments provided helped them in their learning of already existing teaching material. The positive survey results show that the vast majority experientially had improved experiences and results when utilizing the gamification platform of the present disclosure.

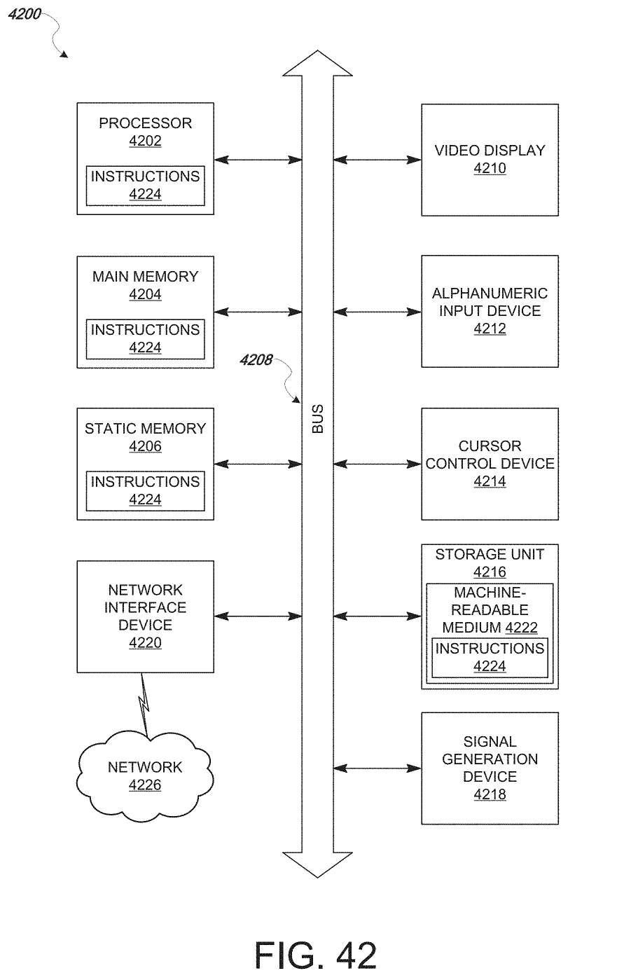

Referring to FIG. 42, the block diagram illustrates components of a machine 4200, according to some example embodiments, able to read instructions 4224 from a machine-readable medium 4222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 42 shows the machine 4200 in the example form of a computer system (e.g., a computer) within which the instructions 4224 (e.g., software, a program, an application, an applet, an app, or other executable code) for causing the machine 4200 to perform any one or more of the methodologies discussed herein may be executed, in whole or in part.

In alternative embodiments, the machine 4200 operates as a stand-alone device or may be connected (e.g., networked) to other machines. In a networked deployment, the machine 4200 may operate in the capacity of a server machine or a client machine in a server-client network environment, or as a peer machine in a distributed (e.g., peer-to-peer) network environment. The machine 4200 may include hardware, software, or combinations thereof, and may, as an example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 4224, sequentially or otherwise, that specify actions to be taken by that machine. Further, while only a single machine 4200 is illustrated, the term “machine” shall also be taken to include any collection of machines that individually or jointly execute the instructions 4224 to perform all or part of any one or more of the methodologies discussed herein.

The machine 4200 includes a processor 4202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 4204, and a static memory 4206, which are configured to communicate with one another via a bus 4208. The processor 4202 may contain microcircuits that are configurable, temporarily or permanently, by some or all of the instructions 4224 such that the processor 4202 is configurable to perform any one or more of the methodologies described herein, in whole or in part. For example, a set of one or more microcircuits of the processor 4202 may be configurable to execute one or more modules (e.g., software modules) described herein.

The machine 4200 may further include a video display 4210 (e.g., a plasma display panel (PDP), a light emitting diode (LED) display, a liquid crystal display (LCD), a projector, a cathode ray tube (CRT), or any other display capable of displaying graphics or video). The machine 4200 may also include an alphanumeric input device 4212 (e.g., a keyboard or keypad), a cursor control device 4214 (e.g., a mouse, a touchpad, a trackball, a joystick, a motion sensor, an eye tracking device, or other pointing instrument), a storage unit 4216, a signal generation device 4218 (e.g., a sound card, an amplifier, a speaker, a headphone jack, or any suitable combination thereof), and a network interface device 4220.

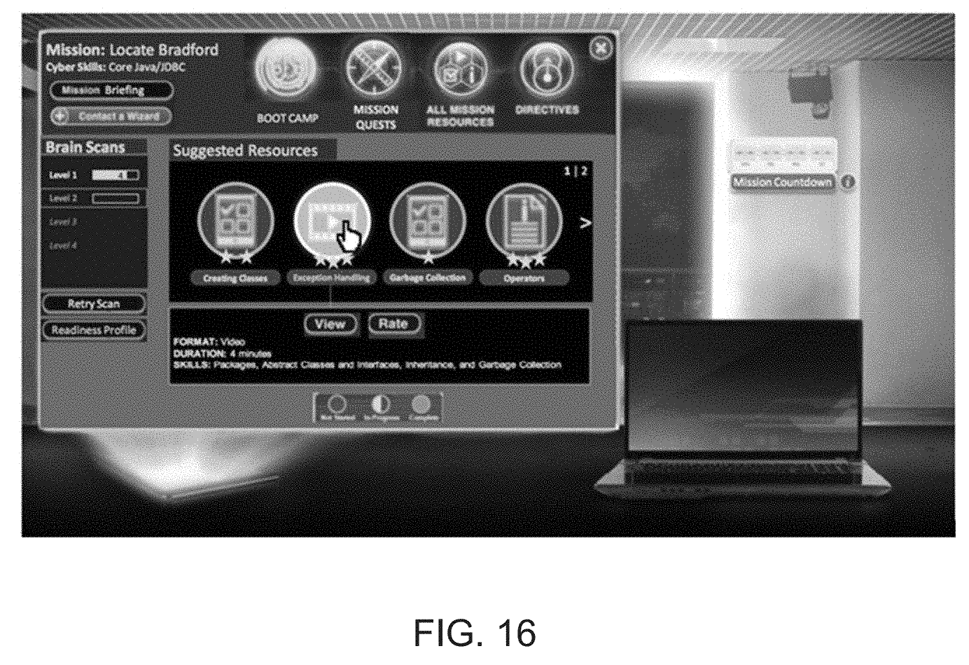

The storage unit 4216 includes the machine-readable medium 4222 (e.g., a tangible and non-transitory machine-readable storage medium) on which are stored the instructions 4224 embodying any one or more of the methodologies or functions described herein, including, for example, any of the descriptions of FIGS. 1-41. The instructions 4224 may also reside, completely or at least partially, within the main memory 4204, within the processor 4202 (e.g., within the processor's cache memory), or both, before or during execution thereof by the machine 4200. The instructions 4224 may also reside in the static memory 4206.

Accordingly, the main memory 4204 and the processor 4202 may be considered machine-readable media 4222 (e.g., tangible and non-transitory machine-readable media). The instructions 4224 may be transmitted or received over a network 4226 via the network interface device 4220. For example, the network interface device 4220 may communicate the instructions 4224 using any one or more transfer protocols (e.g., HTTP). The machine 4200 may also represent an example means for performing any of the functions described herein, including the processes described in FIGS. 1-41.

In some example embodiments, the machine 4200 may be a portable computing device, such as a smartphone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 4222 able to store data temporarily or permanently and may be taken to include, but not be limited to, random-access memory (RAM), read-only memory (ROM), buffer memory, flash memory, and cache memory. While the machine-readable medium 4222 is shown in an example embodiment to be a single medium, the term “machine-readable medium” should be taken to include a single medium or multiple media (e.g., a centralized or distributed database, or associated caches and servers) able to store instructions 4224. The term “machine-readable medium” shall also be taken to include any medium, or combination of multiple media, that is capable of storing the instructions 4224 for execution by the machine 4200, such that the instructions 4224, when executed by one or more processors of the machine 4200 (e.g., processor 4202), cause the machine 4200 to perform any one or more of the methodologies described herein, in whole or in part. Accordingly, a “machine-readable medium” refers to a single storage apparatus or device, as well as cloud-based storage systems or storage networks that include multiple storage apparatuses or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 4222 is non-transitory in that it does not embody a propagating signal. However, labeling the tangible machine-readable medium 4222 as “non-transitory” should not be construed to mean that the medium is incapable of movement; the medium should be considered transportable from one physical location to another. Additionally, since the machine-readable medium 4222 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 4222 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a stand-alone computer system, a client computer system, or a server computer system) or one or more hardware modules of a computer system (e.g., a processor 4202 or a group of processors 4202) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 4202 or other programmable processor 4202. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 4208) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 4202 that are temporarily configured (e.g., by software) or permanently configured to perform the relevant operations. Whether temporarily or permanently configured, such processors 4202 may constitute processor-implemented modules that operate to perform one or more operations or functions described herein. As used herein, “processor-implemented module” refers to a hardware module implemented using one or more processors 4202.

Similarly, the methods described herein may be at least partially processor-implemented, a processor 4202 being an example of hardware. For example, at least some of the operations of a method may be performed by one or more processors 4202 or processor-implemented modules. As used herein, “processor-implemented module” refers to a hardware module in which the hardware includes one or more processors 4202. Moreover, the one or more processors 4202 may also operate to support performance of the relevant operations in a “cloud computing” environment or as a “software as a service” (SaaS). For example, at least some of the operations may be performed by a group of computers (as examples of machines 4200 including processors 4202), with these operations being accessible via a network 4226 (e.g., the Internet) and via one or more appropriate interfaces (e.g., an API).

The performance of certain operations may be distributed among the one or more processors 4202, not only residing within a single machine 4200, but deployed across a number of machines 4200. In some example embodiments, the one or more processors 4202 or processor-implemented modules may be located in a single geographic location (e.g., within a home environment, an office environment, or a server farm). In other example embodiments, the one or more processors 4202 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 4200 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A system for converting client training material into an interactive gamification program, the system comprising:
at least one processor; and
at least one memory coupled to the at least one processor;
the at least one processor configured to:
access client training material provided by the client from an external source;
integrate the client training material into an interactive gamification program, the gamification program including:
a plurality of learning modules that include subsets of training material from the client training material;
a user interface of accessing the plurality of learning modules;
a testing module configured to assess a user's proficiency of each subset of training material among the client training material;
a storyline comprised of story chapters that a user progressively unlocks based on the user progressively showing proficiency of each subset of training material provided by the client; and
an achievement module comprising a record of achievements earned by the user for demonstrating proficiency of each subset of training material; and
cause display of the user interface to allow interaction with the gamification program.

2. The system of claim 1, wherein the gamification program further includes:
a pre-assessment program configured to determine the user's proficiency in each of the plurality of learning modules before the user interfaces with any of the plurality of learning modules; and
a real-time personalized learning plan module configured to generate a set of personalized training material derived from the client training material that addresses deficiencies in the user's understanding of the plurality of learning modules based on results from the pre-assessment program;
wherein the at least one processor is further configured to integrate the personalized training material into the storyline such that the story chapters are progressively unlocked based on the user showing progressive proficiency of progressively more challenging portions of the personalized training material.

3. The system of claim 2, wherein the personalized learning plan module is configured to generate the set of personalized training material based further from machine learning techniques that analyze how long the user spent on questions in the pre-assessment program and a plurality of ratings provided by a plurality of users that rate how valuable questions in the pre-assessment program are.

4. The system of claim 2, wherein the personalized learning plan module is configured to generate the set of personalized training material based further from machine learning techniques that analyze past personalized training materials of past users to determine how effective the past personalized training materials were in addressing deficiencies in the past users.

5. The system of claim 1, wherein the at least one processor is further configured to:
store test results of the user for each subset of the training material in the at least one memory;
aggregate a plurality of test results from a plurality of other users along with the rest results of the user; and
generate predictive performance results of the plurality of other users and the user that generalize an overall proficiency among the plurality of other users and the user.

6. The system of claim 5, wherein the at least one processor is further configured to cause display of a dashboard summarizing the predictive performance results.

7. The system of claim 1, wherein the at least one processor is further configured to:
store, in the at least one memory, a level of user activity by the user interfacing with gamification program; and
predict a level of training module completion based on the stored level of user activity.

8. The system of claim 1, wherein the at least one processor is further configured to:
store, in the at least one memory, an amount of time spent by the user interfacing with a particular training module; and
predict a probability of success that the user will complete said particular training module based on the stored level of amount of time.

9. The system of claim 1, wherein the gamification program further includes an adaptive analytical module configured to:
analyze the user's progress in the plurality of learning modules; and
cause display of suggested supplemental learning resources to aide the user in improving proficiency of at least one of the plurality of learning modules.

10. The system of claim 9, wherein the analytical module is further configured to calculate a correlation between performance-based and knowledge-based assessments and revise the plurality of learning modules to remove a learning module that shows low effectiveness in improving proficiency or adds a learning module that shows high effectiveness in improving proficiency.

11. A method by a gamification platform for converting client training material into an interactive gamification program, the method comprising:
accessing the client training material provided by the client from an external source;
integrating the client training material into an interactive gamification program;
generating a plurality of learning modules in the gamification program that include subsets of training material from the client training material;
generating a user interface for accessing the plurality of learning modules;
generating a testing module in the gamification platform configured to assess a user's proficiency of each subset of training material among the client training material;
generating a storyline comprised of story chapters that a user progressively unlocks based on the user progressively showing proficiency of each subset of training material provided by the client;
generating an achievement module comprising a record of achievements earned by the user for demonstrating proficiency of each subset of training material; and
causing display of the user interface to allow interaction with the gamification program.

12. The method of claim 11, further comprising:
generating a pre-assessment program in the gamification program configured to determine the user's proficiency in each of the plurality of learning modules before the user interfaces with any of the plurality of learning modules;
generating a real-time personalized learning plan module in the gamification program configured to generate a set of personalized training material derived from the client training material that addresses deficiencies in the user's understanding of the plurality of learning modules based on results from the pre-assessment program; and
integrating the personalized training material into the storyline such that the story chapters are progressively unlocked based on the user showing progressive proficiency of progressively more challenging portions of the personalized training material.

13. The method of claim 12, wherein the personalized learning plan module is configured to generate the set of personalized training material based further from machine learning techniques that analyze how long the user spent on questions in the pre-assessment program and a plurality of ratings provided by a plurality of users that rate how valuable questions in the pre-assessment program are.

14. The method of claim 12, wherein the personalized learning plan module is configured to generate the set of personalized training material based further from machine learning techniques that analyze past personalized training materials of past users to determine how effective the past personalized training materials were in addressing deficiencies in the past users.

15. The method of claim 11, further comprising:
storing, in at least one memory of the gamification platform, test results of the user for each subset of the training material in the at least one memory;
aggregating a plurality of test results from a plurality of other users along with the rest results of the user; and
generating predictive performance results of the plurality of other users and the user that generalize an overall proficiency among the plurality of other users and the user.

16. The method of claim 15, further comprising causing display of a dashboard summarizing the predictive performance results.

17. The method of claim 11, further comprising:
storing, in at least one memory of the gamification platform, a level of user activity by the user interfacing with gamification program; and
predicting a level of training module completion based on the stored level of user activity.

18. The method of claim 11, further comprising:
storing, in at least one memory of the gamification platform, an amount of time spent by the user interfacing with a particular training module; and
predicting a probability of success that the user will complete said particular training module based on the stored level of amount of time.

19. The method of claim 1, further comprising:
analyzing, by an analytical module of the gamification platform, the user's progress in the plurality of learning modules; and
causing display of suggested supplemental learning resources to aide the user in improving proficiency of at least one of the plurality of learning modules.

20. The method of claim 19, wherein analytical module is further configured to calculate a correlation between performance-based and knowledge-based assessments and revise the plurality of learning modules to remove a learning module that shows low effectiveness in improving proficiency or adds a learning module that shows high effectiveness in improving proficiency.
